(19) United States
(12) Patent Application Publication
(10) Pub. No.: US 2018/0181283 A1
(43) Pub. Date: Jun. 28, 2018

(54) MOBILE TERMINAL AND METHOD FOR CONTROLLING THE SAME

(71) Applicant: LG ELECTRONICS INC., Seoul (KR)

(72) Inventors: Juhee Jang, Seoul (KR); Jeeyoung Chun, Seoul (KR); Kyungdong Choi, Seoul (KR)

(73) Assignee: LG ELECTRONICS INC., Seoul (KR)

(21) Appl. No.: 15/853,354

(22) Filed: Dec. 22, 2017

(30) Foreign Application Priority Data
Dec. 23, 2016 (KR) 10-2016-0177536
Dec. 23, 2016 (KR) 10-2016-0177537

(51) Int. Cl. G06F 3/0484; G06F 3/041; H04N 1/00

(52) U.S. Cl. CPC G06F 3/04842; H04N 1/00442; G06F 3/0414; G06F 3/0416

(57) ABSTRACT

A mobile terminal is disclosed, which comprises a memory configured to store a plurality of images, a display unit configured to display an execution screen of a camera application, a camera configured to acquire a preview image and a controller configured to control the display unit to display the preview image on a first area within the execution screen, wherein the controller is further configured to control the display unit to display a plurality of thumbnail images corresponding to a plurality of images stored in the memory on a second area within the execution screen.

### CROSS-REFERENCE TO RELATED APPLICATIONS

Pursuant to 35 U.S.C. § 119(a), this application claims the benefit of earlier filing date and right of priority to Korean Application Nos. 10-2016-0177536, filed on Dec. 23, 2016, and 10-2016-0177537, filed on Dec. 23, 2016, the contents of which are all hereby incorporated by reference herein in their entirety.

### BACKGROUND OF THE INVENTION

### Field of the Invention

The present invention relates to a mobile terminal and a method for controlling the same.

### Discussion of the Related Art

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

Meanwhile, according to the related art, only one thumbnail image corresponding to an image taken most recently among images stored in a memory is displayed on an execution screen of a camera application. Therefore, according to the related art, a problem occurs in that a user cannot take an image while identifying a plurality of images stored in the memory. That is, according to the related art, a problem occurs in that a user should take an image by executing a camera application after identifying the images stored in the memory through a gallery application to take an image while identifying the images stored in the memory. In other words, a technique of identifying images stored in a memory and at the same time taking an image through a camera application has not existed in the related art.

Recently, an image is often taken with a concept similar to that of the image taken in the related art. However, as described above, according to the related art, there is no method for taking an image with reference to another image in the middle of taking an image within one device.

Meanwhile, users who desire to take an image in various manners are increasing. Particularly, users who desire to take an image having the same composition as that of an image taken previously and edit the images in one image are increasing. However, a technique of using images stored in a memory 170 when taking an image does not exist in the related art.

Therefore, it is urgently required to develop a mobile terminal and a method for controlling the same, which solves the problems of the mobile terminal according to the related art.

### SUMMARY OF THE INVENTION

Accordingly, an object of the present invention is to address the above-noted and other problems.

An object of the present invention is to provide a mobile terminal and a method for controlling the same, in which a user can identify a plurality of images stored in a memory simultaneously with taking an image.

Technical tasks obtainable from the present invention are non-limited by the above-mentioned technical tasks. And, other unmentioned technical tasks can be clearly understood from the following description by those having ordinary skill in the technical field to which the present invention pertains.

To achieve these objects and other advantages and in accordance with the purpose of the specification, as embodied and broadly described herein, a mobile terminal according to one embodiment of the present invention comprises a memory configured to store a plurality of images, a display unit configured to display an execution screen of a camera application, a camera configured to acquire a preview image and a controller configured to control the display unit to display the preview image on a first area within the execution screen, wherein the controller is further configured to control the display unit to display a plurality of thumbnail images corresponding to a plurality of images stored in the memory on a second area within the execution screen.

In another aspect of the present invention, a mobile terminal according to one embodiment of the present invention comprises a memory configured to store a plurality of images, a display unit configured to display an execution screen of a camera application, a camera configured to acquiring a preview image and a controller configured to control the display unit to display the preview image on a first area within the execution screen, wherein the controller is further configured to control the display unit to display a plurality of thumbnail images corresponding to a plurality of images stored in the memory on a second area within the execution screen, and in response to a first input for selecting the first thumbnail image among the plurality of thumbnail images, control the display unit to overlap a first image corresponding to the first thumbnail image on the preview image, and wherein the first image has transparency.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

A mobile terminal and a method for controlling the same according to the present invention provide the following effects and/or features.

According to at least one of the embodiments of the present invention, it is advantageous that a user can identify a plurality of images stored in a memory simultaneously with taking an image.

According to at least one of the embodiments of the present invention, it is advantageous that a user can easily follow a composition of an image of a specialist or a well-taken image even though the user is not a photo specialist.

According to at least one of the embodiments of the present invention, it is advantageous that a user can use images stored in a memory when taking an image.

It is to be understood that both the foregoing general description and the following detailed description of the present invention are exemplary and explanatory and are intended to provide further explanation of the invention as claimed.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1A is a block diagram of a mobile terminal in accordance with the present disclosure;

FIGS. 1B and 1C are conceptual views of one example of the mobile terminal, viewed from different directions;

FIG. 2 is a conceptual view of a deformable mobile terminal according to an alternative embodiment of the present disclosure;

FIG. 3 is a conceptual view of a wearable mobile terminal according to another alternative embodiment of the present disclosure;

FIG. 4 is a conceptual view of a wearable mobile terminal according to another alternative embodiment of the present disclosure;

FIG. 5 is a flow chart illustrating an example of a method for displaying a plurality of thumbnail images corresponding to a plurality of images stored in a memory on an execution screen of a camera application in a mobile terminal according to one embodiment of the present invention;

FIG. 6 is a view illustrating an example of an execution screen of a camera application displayed in a mobile terminal according to one embodiment of the present invention;

FIG. 7 is a view illustrating another example of an execution screen of a camera application displayed in a mobile terminal according to one embodiment of the present invention;

FIG. 8 is a view illustrating an example of a method for displaying a plurality of thumbnail images in accordance with an aspect ratio of a preview image acquired through a camera in a mobile terminal according to one embodiment of the present invention;

FIG. 9 is a view illustrating an example of a method for displaying a plurality of thumbnail images on an execution screen of a camera application in due order in a mobile terminal according to one embodiment of the present invention;

FIG. 10 is a flow chart illustrating an example of a method for displaying an image corresponding to a specific thumbnail image in a mobile terminal according to one embodiment of the present invention;

FIGS. 11 and 12 are views illustrating an example of a method for selecting a specific one of a plurality of thumbnail images in a mobile terminal according to one embodiment of the present invention;

FIG. 13 is a view illustrating an animation effect provided when an image corresponding to a thumbnail image selected instead of a preview image is displayed in a mobile terminal according to one embodiment of the present invention;

FIG. 14 is a view illustrating an example of a method for changing an execution screen of a camera application in accordance with a command for selecting a specific thumbnail image displayed on the execution screen of the camera application in a mobile terminal according to one embodiment of the present invention;

FIGS. 15 and 16 are views illustrating an example of a method for displaying a preview image acquired through a camera when an image corresponding to a specific thumbnail image is displayed on an execution screen of a camera application in a mobile terminal according to one embodiment of the present invention;

FIG. 17 is a view illustrating an example of a method for changing a size of an area on which a plurality of thumbnail images are displayed in a mobile terminal according to one embodiment of the present invention;

FIGS. 18 to 20 are views illustrating an example of a method for processing images stored in a memory in a mobile terminal according to one embodiment of the present invention;

FIG. 21 is a view illustrating an example of a method for processing a plurality of images stored in a memory by using an execution screen of a camera application in a mobile terminal according to one embodiment of the present invention;

FIGS. 22 and 23 are views illustrating an example of a method for displaying a preview image in a state that images stored in a memory are displayed on an execution screen of a camera application in a mobile terminal according to one embodiment of the present invention;

FIGS. 24 and 25 are views illustrating an example of a method for extracting an image including an object corresponding to an object included in a preview image and displaying a thumbnail image corresponding to the extracted image in a mobile terminal according to one embodiment of the present invention;

FIG. 26 is a flow chart illustrating an example of a method for using images stored in a memory when taking an image in a mobile terminal according to one embodiment of the present invention;

FIG. 27 is a view illustrating an example of a method for using images stored in a memory when taking an image in a mobile terminal according to one embodiment of the present invention;

FIG. 28 is a view illustrating an example of a method for displaying an image selected by a user and an image taken through a camera together in a mobile terminal according to one embodiment of the present invention;

FIGS. 29 to 31 are views illustrating an example of a method for controlling an image displayed on an execution screen of a camera application in a mobile terminal according to one embodiment of the present invention;

FIG. 32 is a view illustrating an example of a method for displaying a plurality of images together with a preview image on an execution screen of a camera application in a mobile terminal according to one embodiment of the present invention;

FIG. 33 is a view illustrating another example of a method for displaying a plurality of images together with a preview image on an execution screen of a camera application in a mobile terminal according to one embodiment of the present invention;

FIG. 34 is a view illustrating other example of a method for displaying a plurality of images together with a preview image on an execution screen of a camera application in a mobile terminal according to one embodiment of the present invention;

FIG. 35 is a flow chart illustrating another example of a method for using images stored in a memory when taking an image in a mobile terminal according to one embodiment of the present invention;

FIG. 36 is a view illustrating another example of a method for using images stored in a memory when taking an image in a mobile terminal according to one embodiment of the present invention;

FIG. 37 is a view illustrating an example of a method for overlapping images stored in a memory on a preview image acquired through a camera in a mobile terminal according to one embodiment of the present invention; and

FIG. 38 is a view illustrating an example of a method for controlling transparency of an image in a mobile terminal according to one embodiment of the present invention.

### DETAILED DESCRIPTION OF THE PREFERRED EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

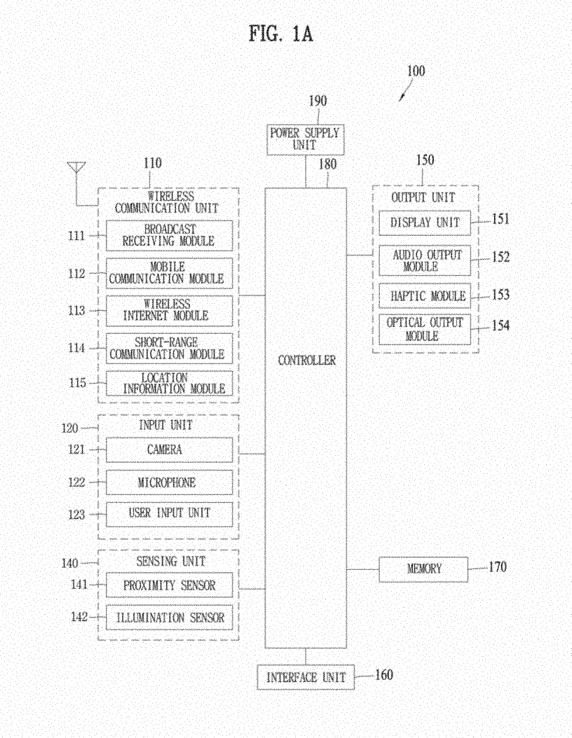

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 processes signals, data, information and the like inputted or outputted through the above-mentioned components and/or runs application programs saved in the memory 170, thereby processing or providing a user with appropriate information and/or functions.

The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least one portion of the respective components mentioned in the foregoing description can cooperatively operate to embody operations, controls or controlling methods of the mobile terminal according to various embodiments of the present invention mentioned in the following description. Moreover, the operations, controls or controlling methods of the mobile terminal can be embodied in the mobile terminal by running at least one or more application programs saved in the memory 170.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may be provided with the display unit 151, the first audio output unit 152a, the second audio output unit 152b, the proximity sensor 141, the illumination sensor 142, the optical output unit 154, the first camera 121a, the second camera 121b, the first manipulating unit 123a, the second manipulating unit 123b, the microphone 122, the interface unit 160, and the like.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Meanwhile, according to the present invention, it is able to display information processed by the mobile terminal using a flexible display. This is described in detail with reference to the accompanying drawings as follows.

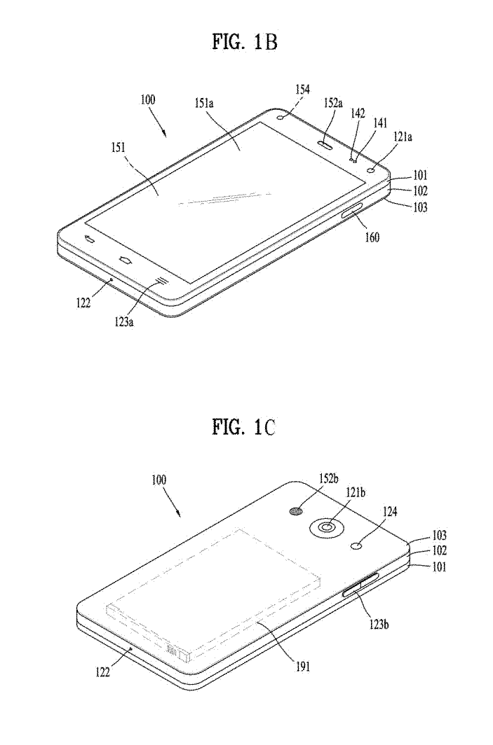

FIG. 2 is a conceptual view of a deformable mobile terminal according to an alternative embodiment of the present invention. In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 may be configured to include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When in a state that the flexible display unit 251 is not deformed (for example, in a state with an infinite radius of curvature and referred to as a first state), a display region of the flexible display unit 251 includes a generally flat surface. When in a state that the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized in such a manner that a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state (or a less curved state) or into a more curved state.

If desired, the flexible display unit 251 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery (not shown in this figure) located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 may transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

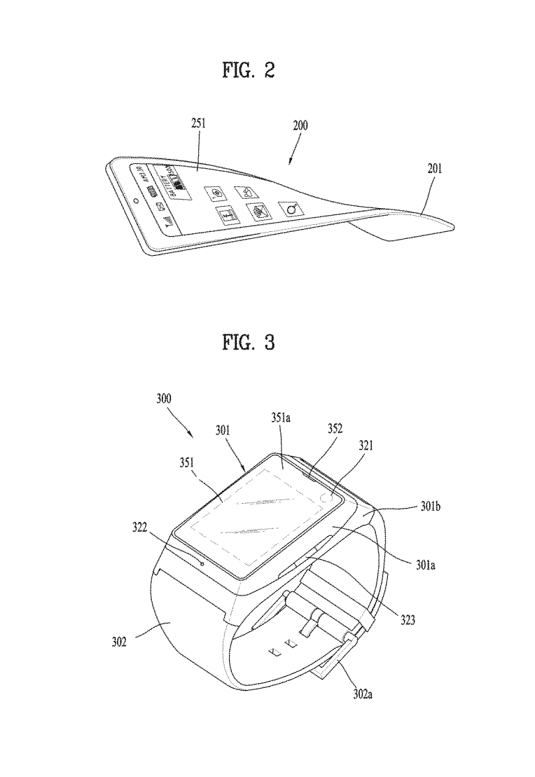

FIG. 3 is a perspective view illustrating one example of a watch-type mobile terminal 300 in accordance with another exemplary embodiment. As illustrated in FIG. 3, the watch-type mobile terminal 300 includes a main body 301 with a display unit 351 and a band 302 connected to the main body 301 to be wearable on a wrist. In general, mobile terminal 300 may be configured to include features that are the same or similar to that of mobile terminal 100 of FIGS. 1A-1C.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, additional function keys may be minimized or eliminated. For example, when the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion (not shown) electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

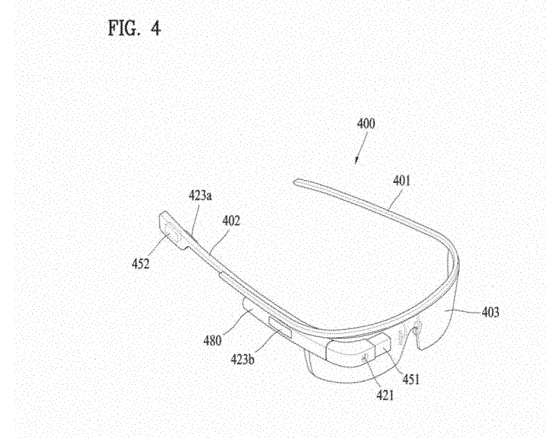

FIG. 4 is a perspective view illustrating one example of a glass-type mobile terminal 400 according to another exemplary embodiment. The glass-type mobile terminal 400 can be wearable on a head of a human body and provided with a frame (case, housing, etc.) therefor. The frame may be made of a flexible material to be easily worn. The frame of mobile terminal 400 is shown having a first frame 401 and a second frame 402, which can be made of the same or different materials. In general, mobile terminal 400 may be configured to include features that are the same or similar to that of mobile terminal 100 of FIGS. 1A-1C.

The frame may be supported on the head and defines a space for mounting various components. As illustrated, electronic components, such as a control module 480, an audio output module 452, and the like, may be mounted to the frame part. Also, a lens 403 for covering either or both of the left and right eyes may be detachably coupled to the frame part.

The control module 480 controls various electronic components disposed in the mobile terminal 400. The control module 480 may be understood as a component corresponding to the aforementioned controller 180. FIG. 4 illustrates that the control module 480 is installed in the frame part on one side of the head, but other locations are possible.

The display unit 451 may be implemented as a head mounted display (HMD). The HMD refers to display techniques by which a display is mounted to a head to show an image directly in front of a user's eyes. In order to provide an image directly in front of the user's eyes when the user wears the glass-type mobile terminal 400, the display unit 451 may be located to correspond to either or both of the left and right eyes. FIG. 4 illustrates that the display unit 451 is located on a portion corresponding to the right eye to output an image viewable by the user's right eye.

The display unit 451 may project an image into the user's eye using a prism. Also, the prism may be formed from optically transparent material such that the user can view both the projected image and a general visual field (a range that the user views through the eyes) in front of the user.

In such a manner, the image output through the display unit 451 may be viewed while overlapping with the general visual field. The mobile terminal 400 may provide an augmented reality (AR) by overlaying a virtual image on a realistic image or background using the display.

The camera 421 may be located adjacent to either or both of the left and right eyes to capture an image. Since the camera 421 is located adjacent to the eye, the camera 421 can acquire a scene that the user is currently viewing. The camera 421 may be positioned at most any location of the mobile terminal. In some embodiments, multiple cameras 421 may be utilized. Such multiple cameras 421 may be used to acquire a stereoscopic image.

The glass-type mobile terminal 400 may include user input units 423a and 423b, which can each be manipulated by the user to provide an input. The user input units 423a and 423b may employ techniques which permit input via a tactile input. Typical tactile inputs include a touch, push, or the like. The user input units 423a and 423b are shown operable in a pushing manner and a touching manner as they are located on the frame part and the control module 480, respectively.

If desired, mobile terminal 400 may include a microphone which processes input sound into electric audio data, and an audio output module 452 for outputting audio. The audio output module 452 may be configured to produce audio in a general audio output manner or an osteoconductive manner. When the audio output module 452 is implemented in the osteoconductive manner, the audio output module 452 may be closely adhered to the head when the user wears the mobile terminal 400 and vibrate the user's skull to transfer sounds.

A communication system which is operable with the variously described mobile terminals will now be described in more detail. Such a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A (Long Term Evolution-Advanced)), Global System for Mobile Communications (GSM), and the like.

By way of a non-limiting example only, further description will relate to a CDMA communication system, but such teachings apply equally to other system types including a CDMA wireless communication system as well as OFDM (Orthogonal Frequency Division Multiplexing) wireless communication system. A CDMA wireless communication system generally includes one or more mobile terminals (MT or User Equipment, UE) 100, one or more base stations (BSs, NodeB, or evolved NodeB), one or more base station controllers (BSCs), and a mobile switching center (MSC). The MSC is configured to interface with a conventional Public Switched Telephone Network (PSTN) and the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the CDMA wireless communication system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.” Alternatively, individual sectors of a given base station may be referred to as cell sites.

A broadcasting transmitter (BT) transmits a broadcast signal to the mobile terminals 100 operating within the system. The broadcast receiving module 111 of FIG. 1A is typically configured inside the mobile terminal 100 to receive broadcast signals transmitted by the BT.

Global Positioning System (GPS) satellites for locating the position of the mobile terminal 100, for example, may cooperate with the CDMA wireless communication system. Useful position information may be obtained with greater or fewer satellites than two satellites. It is to be appreciated that other types of position detection technology, (i.e., location technology that may be used in addition to or instead of GPS location technology) may alternatively be implemented. If desired, at least one of the GPS satellites may alternatively or additionally be configured to provide satellite DMB transmissions.

The location information module 115 is generally configured to detect, calculate, or otherwise identify a position of the mobile terminal. As an example, the location information module 115 may include a Global Position System (GPS) module, a Wi-Fi module, or both. If desired, the location information module 115 may alternatively or additionally function with any of the other modules of the wireless communication unit 110 to obtain data related to the position of the mobile terminal.

A typical GPS module 115 can measure an accurate time and distance from three or more satellites, and accurately calculate a current location of the mobile terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites.

Furthermore, the GPS module can acquire speed information in real time to calculate a current position. Sometimes, accuracy of a measured position may be compromised when the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Fi positioning system (WPS) refers to a location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module.

The Wi-Fi positioning system may include a Wi-Fi location determination server, a mobile terminal, a wireless access point (AP) connected to the mobile terminal, and a database stored with wireless AP information.

The mobile terminal connected to the wireless AP may transmit a location information request message to the Wi-Fi location determination server. The Wi-Fi location determination server extracts the information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AP.

The information of the wireless AP extracted based on the location information request message of the mobile terminal 100 may include one or more of media access control (MAC) address, service set identification (SSID), received signal strength indicator (RSSI), reference signal received Power (RSRP), reference signal received quality (RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database.

A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by a mobile terminal, as a position of the mobile terminal. The Cell-ID method is an implementation that is minimally complex, does not require additional costs, and location information can be rapidly acquired. However, in the Cell-ID method, the precision of positioning may fall below a desired threshold when the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of a mobile terminal using a known landmark transmitter.

In addition to these position location methods, various algorithms may be used to extract (analyze) location information of a mobile terminal. Such extracted location information may be transmitted to the mobile terminal 100 through the Wi-Fi location determination server, thereby acquiring location information of the mobile terminal 100.

The mobile terminal 100 can acquire location information by being connected to at least one wireless AP. The number of wireless APs required to acquire location information of the mobile terminal 100 may be variously changed according to a wireless communication environment within which the mobile terminal 100 is positioned.

As previously described with regard to FIG. 1A, the mobile terminal may be configured to include short-range communication techniques such as Bluetooth™, Radio Frequency Identification (RFID), Infrared Data Association (IrDA), Ultra Wideband (UWB), ZigBee, Near Field Communication (NFC), Wireless USB (Wireless Universal Serial Bus), and the like.

A typical NFC module provided at the mobile terminal supports short-range wireless communication, which is a non-contactable type of communication between mobile terminals and generally occurs within about 10 cm. The NFC module may operate in one of a card mode, a reader mode, or a P2P mode. The mobile terminal 100 may further include a security module for storing card information, in order to operate the NFC module in a card mode. The security module may be a physical medium such as Universal Integrated Circuit Card (UICC) (e.g., a Subscriber Identification Module (SIM) or Universal SIM (USIM)), a secure micro SD and a sticker, or a logical medium (e.g., embedded Secure Element (SE)) embedded in the mobile terminal. Single Wire Protocol (SWP)-based data exchange may be performed between the NFC module and the security module.

In a case where the NFC module operates in a card mode, the mobile terminal may transmit card information on a general IC card to the outside. More specifically, if a mobile terminal having card information on a payment card (e. g, a credit card or a bus card) approaches a card reader, a short-range mobile payment may be executed. As another example, if a mobile terminal which stores card information on an entrance card approaches an entrance card reader, an entrance approval procedure may start. A card such as a credit card, a traffic card, or an entrance card may be included in the security module in the form of applet, and the security module may store card information on the card mounted therein. Card information for a payment card may include any of a card number, a remaining amount and usage history, and the like. Card information of an entrance card may include any of a user's name, a user's number (e.g., undergraduate number or staff number), an entrance history, and the like.

When the NFC module operates in a reader mode, the mobile terminal can read data from an external tag. The data received from the external tag by the mobile terminal may be coded into the NFC Data Exchange Format defined by the NFC Forum. The NFC Forum generally defines four record types. More specifically, the NFC Forum defines four Record Type Definitions (RTDs) such as smart poster, text, Uniform Resource Identifier (URI), and general control. If the data received from the external tag is a smart poster type, the controller may execute a browser (e.g., Internet browser). If the data received from the external tag is a text type, the controller may execute a text viewer. If the data received from the external tag is a URI type, the controller may execute a browser or originate a call. If the data received from the external tag is a general control type, the controller may execute a proper operation according to control content.

In some cases in which the NFC module operates in a P2P (Peer-to-Peer) mode, the mobile terminal can execute P2P communication with another mobile terminal. In this case, Logical Link Control Protocol (LLCP) may be applied to the P2P communication. For P2P communication, connection may be generated between the mobile terminal and another mobile terminal. This connection may be categorized as a connectionless mode which ends after one packet is switched, and a connection-oriented mode in which packets are switched consecutively. For a typical P2P communication, data such as an electronic type name card, address information, a digital photo and a URL, a setup parameter for Bluetooth connection, Wi-Fi connection, etc. may be switched. The P2P mode can be effectively utilized in switching data of a small capacity, because an available distance for NFC communication is relatively short.

Further preferred embodiments will be described in more detail with reference to additional drawing figures. It is understood by those skilled in the art that the present features can be embodied in several forms without departing from the characteristics thereof.

Hereinafter, the mobile terminal according to the embodiments of the present invention will be described based on the mobile terminal 100 shown in FIG. 1A. However, the mobile terminal according to one embodiment of the present invention may be implemented as the mobile terminals 200, 300 and 400 shown in FIGS. 2 to 4.

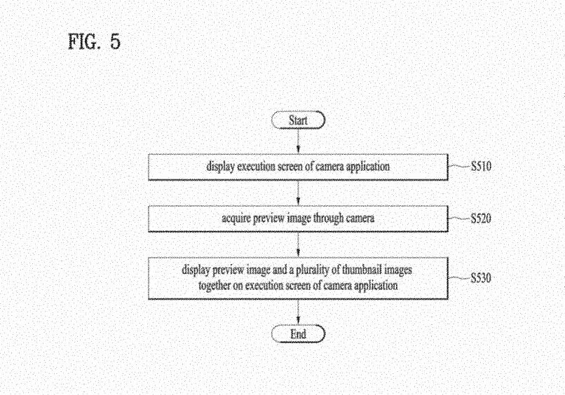

According to one embodiment of the present invention, the controller 180 may control the display unit 151 to display a plurality of thumbnail images corresponding to a plurality of images on an execution screen of a camera application. That is, the user may take an image through a camera while referring to images stored in the memory. This will be described with reference to FIGS. 5 to 9.

FIG. 5 is a flow chart illustrating an example of a method for displaying a plurality of thumbnail images corresponding to a plurality of images stored in a memory on an execution screen of a camera application in a mobile terminal according to one embodiment of the present invention.

According to one embodiment of the present invention, the memory 170 may store a plurality of images. In this case, the plurality of images may include images acquired through the camera, images acquired through a capture, and images received from the external server or the external device.

However, without limitation to this case, images may not be stored in the memory 170, or only one image may be stored in the memory 170. For convenience of description, it is assumed that a plurality of images are stored in the memory 170. The embodiments which will be described hereinafter may be applied to even the case that one image is stored in the memory 170 or the case that no image is stored therein.

The camera application may be stored in the memory 170. The camera application may be stored in the memory 170 from the release timing, may be installed during upgrade of an application program or firmware, or may separately be stored in the memory 170 by the user.

In more detail, if the controller 180 senses any one of an input for pushing a physical key as much as a predetermined number of times, a touch input for selecting an icon of the camera application displayed on a home screen, and a touch input for dragging the icon of the camera application displayed on a lock screen after touching the icon of the camera application, the controller 180 may recognize the sensed input as an execution command of the camera application. However, without limitation to this case, the controller 180 may control the display unit 151 to display the execution screen if the execution command of the camera application is recognized.

Meanwhile, the controller 180 may enable the camera 121 in accordance with the execution command of the camera application. The controller 180 may acquire a preview image through the enabled camera 121 (S520). The preview image means an image acquired through the camera in real time.

The controller 180 may control the display unit 151 to display the preview image acquired through the camera and the plurality of thumbnail images respectively corresponding to the plurality of images stored in the memory 170 on the execution screen (S530).

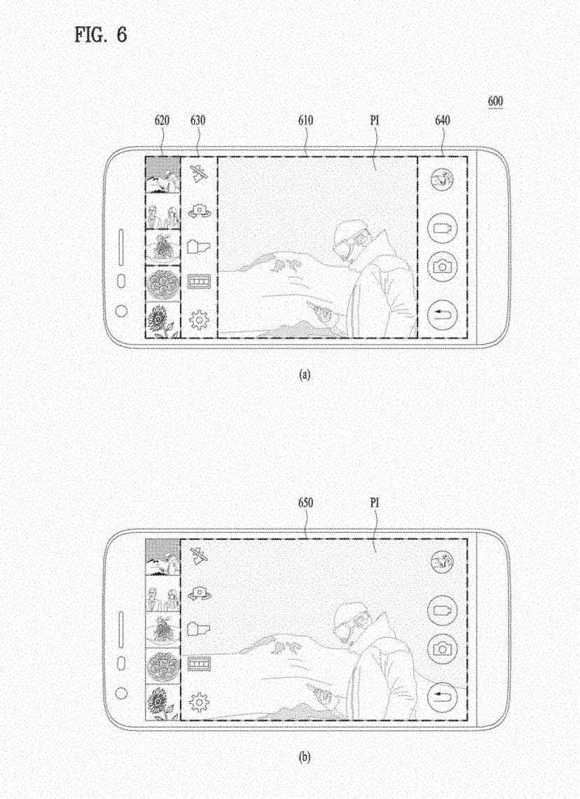

In more detail, the preview image may be displayed on a first area within the execution screen. The plurality of thumbnail images may be displayed on a second area within the execution screen. In this case, the first area and the second area may be one areas different from each other within the execution screen. This will be described in detail with reference to FIG. 6.

Meanwhile, in accordance with the embodiment, the controller 180 may control the display unit 151 to display an indicator corresponding to functions of the camera application on a third area within the execution screen. In this case, the third area may be an area included in the first area on which the preview image is displayed, or may be an area existing between the first area and the second area.

Meanwhile, since the size of the display unit 151 is limited, all of the plurality of thumbnail images corresponding to the plurality of images stored in the memory 170 cannot be displayed on the second area. Therefore, the controller 180 may control the display unit 151 to display the thumbnail images on the second area in accordance with a certain order.

For example, the controller 180 may control the display unit 151 to sequentially display the plurality of thumbnail images on the basis of a photo session of each of the plurality of images stored in the memory 170.

For another example, the controller 180 may control the display unit 151 to sequentially display the plurality of thumbnail images on the basis of a use frequency.

Meanwhile, according to one embodiment of the present invention, the controller 180 may control the display unit 151 to display the plurality of thumbnail images corresponding to images located in a specific folder among the plurality of images stored in the memory 170 on the second area.

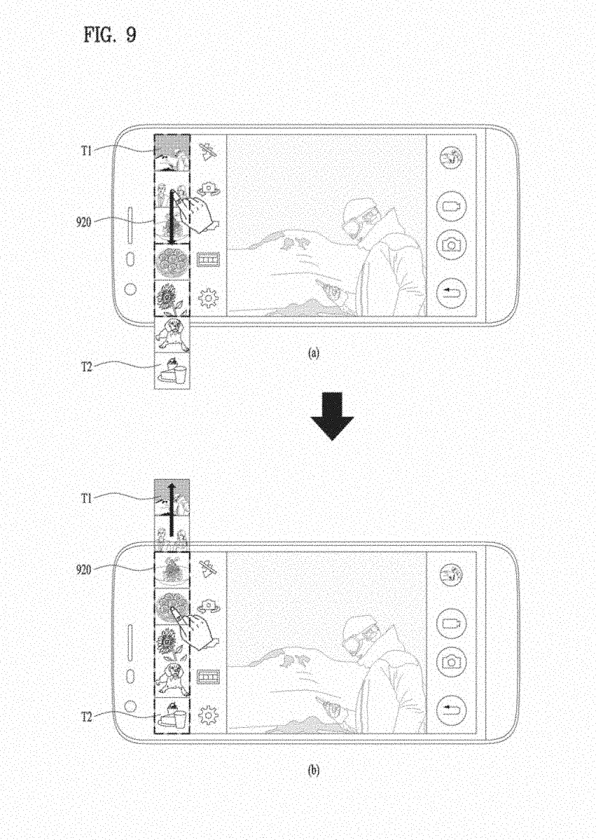

Meanwhile, if a specific input is sensed on the second area, the controller 180 may control the display unit 151 to display another thumbnail image instead of at least one of the plurality of thumbnail images which are currently displayed. This will be described in detail with reference to FIG. 9.

According to this embodiment, it is advantageous that the user may identify the plurality of images stored in the memory in the middle of taking an image.

FIG. 6 is a view illustrating an example of an execution screen of a camera application displayed in a mobile terminal according to one embodiment of the present invention.

In respect of FIG. 6, it is assumed that the mobile terminal 100 is a horizontal mode. In this case, the horizontal mode may mean the state that a top end of the mobile terminal is headed for a left side or a right side, or may mean the state that the top end of the mobile terminal is not headed for a downward side or an upward side.

Referring to (a) of FIG. 6, the controller 180 may display a preview image PI acquired through the camera 121 on a first area 610 within an execution screen 600 of the camera application.

The controller 180 may control the display unit 151 to display the plurality of thumbnail images respectively corresponding to the plurality of images stored in the memory 170 on a second area 620 within the execution screen 600. However, without limitation to this, the plurality of thumbnail images may be displayed on the preview image PI.

Meanwhile, since the size of the display unit 151 is limited, all of the plurality of thumbnail images stored in the memory 170 cannot be displayed on the second area 620. Therefore, the controller 180 may control the display unit 151 to display the thumbnail images in accordance with a certain order.

For example, the controller 180 may control the display unit 151 to sequentially display the plurality of thumbnail images on the second area 620 on the basis of a photo session of each of the plurality of images stored in the memory 170.

In more detail, the controller 180 may control the display unit 151 to display a first thumbnail image corresponding to the most recently captured image on the uppermost end within the second area 620. Also, the controller 180 may control the display unit 151 to display the plurality of thumbnail images respectively corresponding to the plurality of images stored in the memory 170 below the first thumbnail image in accordance with a time order.

For another example, the controller 180 may control the display unit 151 to sequentially display the plurality of thumbnail images on the basis of a use frequency.

In this case, the use frequency may mean a level selected by the user. For example, the image having a high use frequency may be an image selected most frequently by the user.

In more detail, the controller 180 may control the display unit 151 to display a thumbnail image corresponding to the most frequently used image on the uppermost end within the second area 620. Also, the controller 180 may control the display unit 151 to display the plurality of thumbnail images respectively corresponding to the plurality of images stored in the memory 170 below the thumbnail image corresponding to the most frequently used image in accordance with a use frequency.

Meanwhile, according to one embodiment of the present invention, the controller 180 may control the display unit 151 to display the plurality of thumbnail images corresponding to images located in a specific folder among the plurality of images stored in the memory 170 on the second area. In this case, the specific folder may be a folder selected by the user.

The controller 180 may control the display unit 151 to display an indicator corresponding to functions of the camera application on a third area 630 within the execution screen 600.

In this case, the functions of the camera application may mean those used by the user when an image is captured through the camera application, such as a flash on/off function, a function of changing the camera that takes an image, and a function of changing setup of the camera application.

The indicator corresponding to the functions of the camera application displayed on the third area 630 may be determined from the release timing. However, without limitation to this, the user may separately set the indicator displayed on the third are 630.

Meanwhile, according to one embodiment of the present invention, the indicator displayed on the third area 630 may be one corresponding to the function used as much as a predetermined number of times or more among the functions of the camera application.

For example, if the user uses the flash on/off function as much as the predetermined number of times, the controller 180 may control the display unit 151 to display the indicator corresponding to the flash on/off function on the third area 630.

The controller 180 may control the display unit 151 to display the indicator corresponding to the function used as much as the predetermined number of times or more instead of the indicator corresponding to a function of a low use frequency among the indicators displayed on the third area 630. Therefore, since the mobile terminal automatically displays the indicator corresponding to the frequently used function on the execution screen of the camera application, the user may quickly select the indicator of the frequently used function.

Meanwhile, if a specific input is sensed on the second area, the controller 180 may control the display unit 151 to display another thumbnail image instead of at least one of the plurality of thumbnail images which are currently displayed. This will be described in detail with reference to FIG. 9.

Meanwhile, the controller 180 may display an indicator corresponding to an image capturing function or an indicator corresponding to a video capability on a fourth area 640 within the execution screen. Also, the controller 180 may control the display unit 151 to display an indicator corresponding to a reverse function on the fourth area 640 within the execution screen. Also, the controller 180 may control the display unit 151 to display a thumbnail image corresponding to the most recently captured image on the fourth area 640 within the execution screen.

Meanwhile, the size of the area on which the preview image PI is displayed may be changed in accordance with an aspect ratio of the preview image PI.

For example, if the aspect ratio of the preview image PI is 4:3, the preview image PI may be displayed on the first area 610 as shown in (a) of FIG. 6. In this case, the third area 630 may be located between the first area 610 and the second area 620.

For another example, if the aspect ratio of the preview image PI is 16:9, the preview image PI may be displayed on a fifth area 650 as shown in (b) of FIG. 6. In this case, the fifth area 650 may be an area that includes the third area 630 and the fourth area 640.

That is, the size of the area on which the preview image PI is displayed may be changed in accordance with the aspect ratio of the preview image PI.

According to this embodiment, it is advantageous that the user may take an image with reference to the images previously captured and stored in the memory. Also, it is advantageous that the user may identify the images stored in the memory while taking an image as the thumbnail images corresponding to the plurality of images are provided to one side of the display unit when the image is captured.

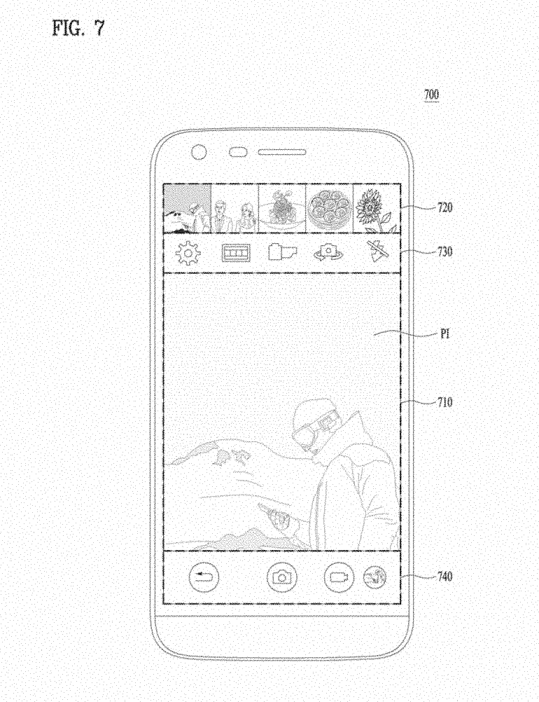

FIG. 7 is a view illustrating another example of an execution screen of a camera application displayed in a mobile terminal according to one embodiment of the present invention. Repeated description of the description made with reference to FIG. 6 will be omitted in FIG. 7, and the example of FIG. 7 will be described based on a difference from FIG. 6.

In respect of FIG. 7, it is assumed that the mobile terminal 100 is a vertical mode and an aspect ratio of a preview image is 4:3. In this case, the vertical mode may mean the state that a top end of the mobile terminal is not headed for a left side or a right side, or may mean the state that the top end of the mobile terminal is headed for a downward side or an upward side.

Referring to FIG. 7, the controller 180 may display a preview image PI acquired through the camera 121 on a first area 710 within an execution screen 700 of the camera application. In this case, the first area 710 may be an area located at the center within the execution screen of the camera application.

However, if the aspect ratio of the preview image PI is changed, the area on which the preview image PI is displayed may be changed. Since this is the same as the description in (b) of FIG. 6, its description will be omitted.

Meanwhile, the controller 180 may control the display unit 151 to display a plurality of thumbnail images respectively corresponding to a plurality of images stored in the memory 170 on a second area 720 within the execution screen 700. In this case, the second area 720 may be located above or below the first area 710.

The controller 180 may control the display unit 151 to display an indicator corresponding to functions of the camera application on a third area 730 within the execution screen 700. In this case, the third area 710 may be located between the first area 710 and the second area 720.

However, the third area 730 may be included in the area on which the preview image PI is displayed as shown in FIG. (b) of FIG. 6.

The controller 180 may display an indicator corresponding to an image capturing function or an indicator corresponding to a video capability on a fourth area 740 within the execution screen. Also, the controller 180 may control the display unit 151 to display an indicator corresponding to a reverse function on the fourth area 740 within the execution screen. Also, the controller 180 may control the display unit 151 to display a thumbnail image corresponding to the most recently captured image on the fourth area 740. In this case, the fourth area 740 may be located below or above the first area 710. However, the fourth area 740 may be included in the area on which the preview image PI is displayed as shown in FIG. (b) of FIG. 6.

According to this embodiment, it is advantageous that the user may take an image with reference to the images previously captured and stored in the memory. Also, it is advantageous that the user may identify the images stored in the memory while taking an image as the thumbnail images corresponding to the plurality of images are provided to one side of the display unit when the image is captured.

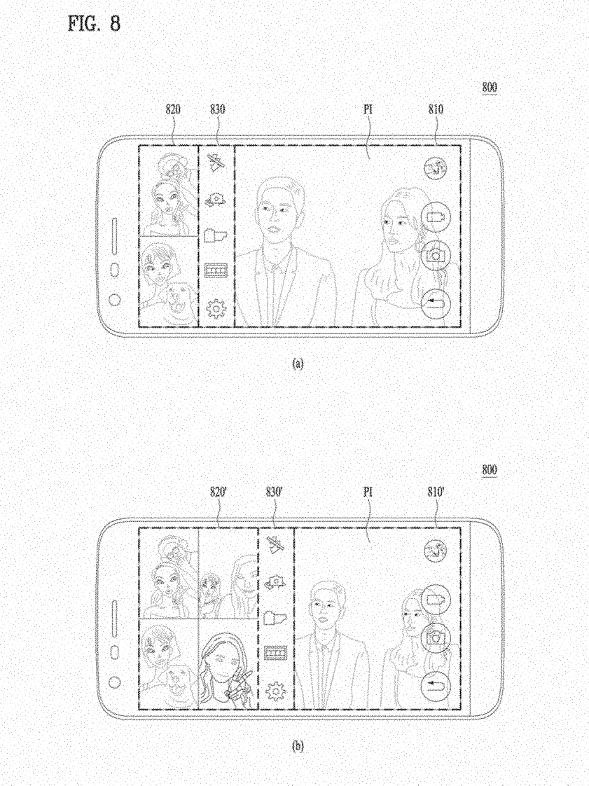

FIG. 8 is a view illustrating an example of a method for displaying a plurality of thumbnail images in accordance with an aspect ratio of a preview image acquired through a camera in a mobile terminal according to one embodiment of the present invention. Repeated description of the description made with reference to FIGS. 6 and 7 will be omitted in FIG. 8, and the example of FIG. 8 will be described based on a difference from FIGS. 6 and 7. In respect of FIG. 8, it is assumed that the mobile terminal 100 is a horizontal mode.

Referring to (a) of FIG. 8, the controller 180 may control the display unit 151 to display a preview image PI acquired through the camera 121 on a first area 810. The controller 180 may control the display unit 151 to display a plurality of thumbnail images respectively corresponding to a plurality of images stored in the memory 170 on a second area 820. The controller 180 may control the display unit 151 to display an indicator corresponding to functions of the camera application on a third area 830. In this case, each of the first area 810, the second area 820 and the third area 830 may be one area within an execution screen 800 of the camera application.

Meanwhile, if the aspect ratio of the preview image PI is changed, the controller 180 may change the size of the first area 810 and the size of the second area 820 on the basis of the changed aspect ratio.

In more detail, if the aspect ratio of the preview image PI is changed from 4:3 shown in (a) of FIGS. 8 to 1:1 shown in (b) of FIG. 8, the controller 180 may change the size of the first area 810 in (a) of FIG. 8 to the size shown in (b) of FIG. 8. In this case, the first area 810′ of which size is changed may be smaller than the first area 810 of which size is not changed.

Also, if the aspect ratio of the preview image PI is changed from 4:3 shown in (a) of FIGS. 8 to 1:1 shown in (b) of FIG. 8, the controller 180 may change the size of the second area 820 in (a) of FIG. 8 to the size shown in (b) of FIG. 8. In this case, the second area 820′ of which size is changed may be greater than the second area 820 of which size is not changed.

Meanwhile, the controller 180 may display the plurality of thumbnail images displayed on the second area 820 in another method in accordance with the aspect ratio of the preview image PI.

In more detail, referring to (a) of FIG. 8, if the aspect ratio of the preview image PI is 4:3, the controller 180 may control the display unit 151 to display the plurality of thumbnail images on the second area 820 one by one in a vertical direction.

Referring to (b) of FIG. 8, as the aspect ratio of the preview image PI is changed, the controller 180 may control the display unit 151 to display the plurality of thumbnail images on the second area 820′, of which size is changed, in pairs in each of horizontal and vertical directions.

Meanwhile, according to one embodiment of the present invention, as the aspect ratio of the preview image PI is changed, the controller 180 may also change the position of the third area 830.

Meanwhile, according to one embodiment of the present invention, the plurality of thumbnail images corresponding to the plurality of images stored in the memory may be displayed on the execution screen of the camera application in due order. This will be described in more detail with reference to FIG. 9.

FIG. 9 is a view illustrating an example of a method for displaying a plurality of thumbnail images on an execution screen of a camera application in due order in a mobile terminal according to one embodiment of the present invention. Repeated description of the description made with reference to FIGS. 5 to 8 will be omitted in FIG. 9, and the example of FIG. 9 will be described based on a difference from FIGS. 5 to 8.

According to one embodiment of the present invention, the plurality of thumbnail images respectively corresponding to the plurality of images stored in the memory 170 may be displayed on a second area 920 of the execution screen of the camera application. In this case, since the size of the second area 920 is limited, all of the plurality of thumbnail images cannot be displayed. Therefore, a predetermined number of thumbnail images among the plurality of thumbnail images may be displayed on the second area 920 in accordance with a certain order.

For example, the controller 180 may control the display unit 151 to sequentially display the plurality of thumbnail images on the basis of a photo session of each of the plurality of images stored in the memory 170.

For another example, the controller 180 may control the display unit 151 to sequentially display the plurality of thumbnail images on the basis of a use frequency.

Meanwhile, if a specific input is sensed on the second area, the controller 180 may control the display unit 151 to display another thumbnail image instead of at least one of the plurality of thumbnail images which are currently displayed.

Referring to (a) of FIG. 9, the controller may control the display unit 151 to display a predetermined number of thumbnail images (for example, 5 thumbnail images) on the second area 920.

If a specific input is sensed on the second area 920, the controller 180 may control the display unit 151 to additionally display thumbnail images, which are not displayed on the second area 920, on the second area 920.

In this case, the specific input may be a touch input for dragging (or flicking) the second area 920 to a specific direction (for example, downward direction) after touching the second area 920.

Meanwhile, referring to (b) of FIG. 9, the controller 180 may control the display unit 151 so as not to display a first thumbnail image T1 displayed on the uppermost end of the second area 920 in accordance with the touch input. The controller 180 may control the display unit 151 so as not to display a second thumbnail image T2, which is not displayed on the second area 920, among the plurality of thumbnail images, on the lowest end of the second area 920. In this case, the controller 180 may provide an animation effect to allow the thumbnail images displayed on the second area 920 to be seen to be pushed up.

As a result, the controller 180 may control the display unit 151 to display the second thumbnail image T2 instead of the first thumbnail image T1 in accordance with the touch input.

According to this embodiment, it is advantageous that the user may identify all the images stored in the memory 170.

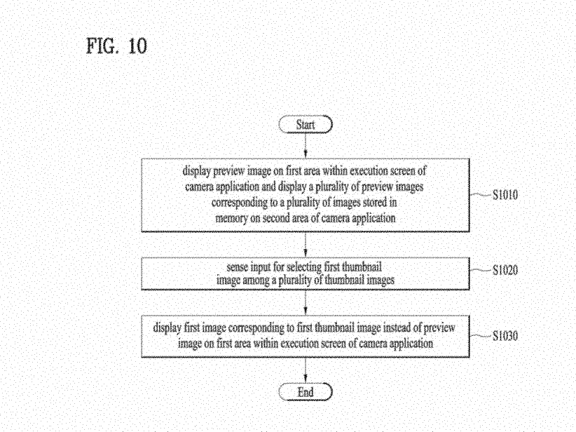

FIG. 10 is a flow chart illustrating an example of a method for displaying an image corresponding to a specific thumbnail image in a mobile terminal according to one embodiment of the present invention. Repeated description of the description made with reference to FIGS. 5 to 9 will be omitted in FIG. 10, and the example of FIG. 10 will be described based on a difference from FIGS. 5 to 9.

The controller 180 may display a preview image acquired through the camera on a first area within an execution screen of the camera application, and may control the display unit 151 to display a plurality of preview images corresponding to a plurality of images stored in the memory on the second area within the execution screen (S1010).

Meanwhile, the controller 180 may sense an input for selecting a first thumbnail image among the plurality of thumbnail images displayed on the second area (S1020). In this case, the input for selecting the first thumbnail image may be a touch input for touching the area, on which the first thumbnail image is displayed, at a predetermined pressure, a touch input for touching the area, on which the first thumbnail image is displayed, for a predetermined time, a touch input for touching the area, on which the first thumbnail image is displayed, as much as a predetermined number of times, or a touch input for touching the area, on which the first thumbnail image is displayed, and then dragging the touched area toward a specific direction.

As the input for selecting the first thumbnail image is sensed (S1020), the controller 180 may control the display unit 151 to display a first image corresponding to the first thumbnail image instead of the preview image on the first area within the execution screen (S1030). That is, since the first image is displayed instead of the preview image, the user may identify the first image at a great size.

In this case, the controller 180 may control the display unit 151 to display the first image on the first area within the execution screen of the camera application in accordance with the input for selecting the first thumbnail image. Alternatively, the controller 180 may control the display unit 151 to display an execution screen of a gallery application on the first area by executing the gallery application in accordance with the input for selecting the first thumbnail image.

Meanwhile, according to one embodiment of the present invention, if the first image instead of the preview image is displayed on the first area, the controller 180 may control the display unit 151 to display the preview image on one area within the execution screen at a small size. Therefore, the user may take an image through the camera while identifying the first image at a great size.

According to this embodiment, it is advantageous that the user may identify a desired specific image at a great size.

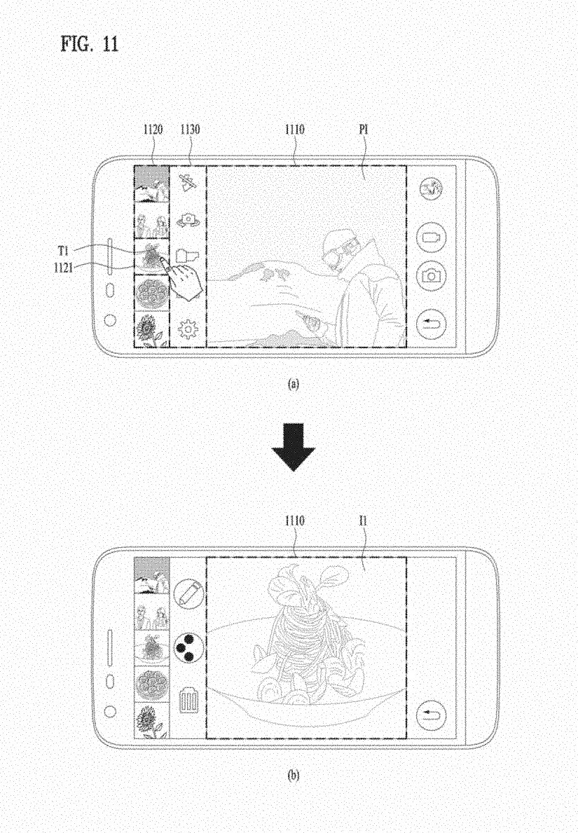

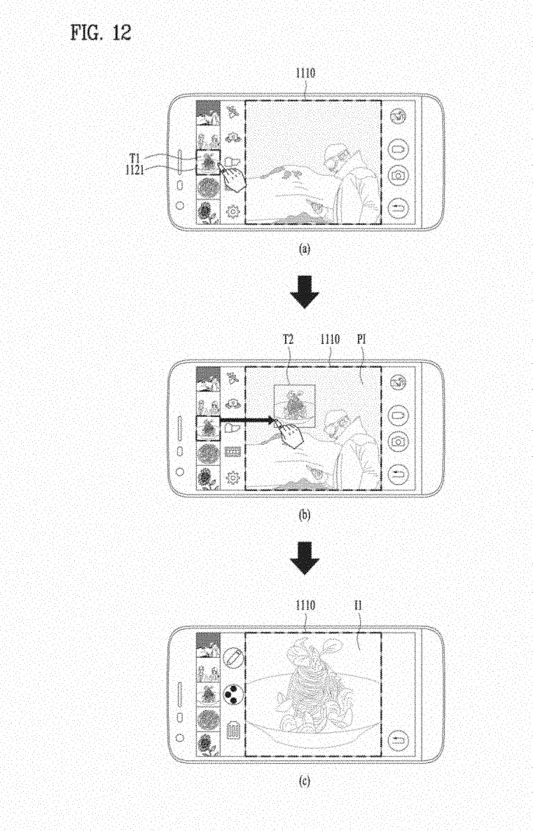

That is, according to one embodiment of the present invention, as a specific one of the plurality of thumbnail images displayed on the execution screen of the camera application is selected, the controller 180 may display the image corresponding to the specific thumbnail image on the execution screen. In this case, the user may display the image on the execution screen through various methods. This will be described in more detail with reference to FIGS. 11 and 12.

FIGS. 11 and 12 are views illustrating an example of a method for selecting a specific one of a plurality of thumbnail images in a mobile terminal according to one embodiment of the present invention. Repeated description of the description made with reference to FIGS. 5 to 10 will be omitted in FIGS. 11 and 12, and the example of FIGS. 11 and 12 will be described based on a difference from FIGS. 5 to 10.

Referring to (a) of FIG. 11, the controller 180 may control the display unit 151 to display a preview image PI acquired through the camera on a first area 1110 within an execution screen of the camera application. The controller 180 may control the display unit 151 to display a plurality of preview images corresponding to a plurality of images stored in the memory 170 on a second area 1120 within the execution screen. The controller 180 may control the display unit 151 to display an indicator corresponding to functions of the camera application on a third area 1130 within the execution screen.

Meanwhile, the controller 180 may control the display unit 151 to display a first image I1, which corresponds to a first thumbnail image Ti as shown in (b) of FIG. 11, instead of the preview image P1 on the first area 1110 in accordance with a command for selecting the first thumbnail image T1 among the plurality of thumbnail images displayed on the second area 1120.

For example, the controller 180 may recognize that the first thumbnail image T1 is selected in accordance with a touch input for touching the area, on which the first thumbnail image T1 is displayed. The controller 180 may control the display unit 151 to display the first image I1 corresponding to the first thumbnail image T1 on the first area.

However, in this case, even in the case that the user touches the area, on which the first thumbnail image T1 is displayed, in error while touching the indicator displayed on the third area 1130, a problem may occur in that it is recognized that the first thumbnail image T1 is selected.

Therefore, to solve the problem, it is preferable that it is recognized that the first thumbnail image T1 is selected through another touch input.

For example, the controller 180 may recognize a touch input for touching the area 1121 on which the first thumbnail image T1 is displayed for a predetermined time (for example, three seconds) as a command for selecting the first thumbnail image T1.

For another example, the controller 180 may recognize a touch input for touching the area 1121 on which the first thumbnail image T1 is displayed for a predetermined number of times (for example, twice) as a command for selecting the first thumbnail image T1.

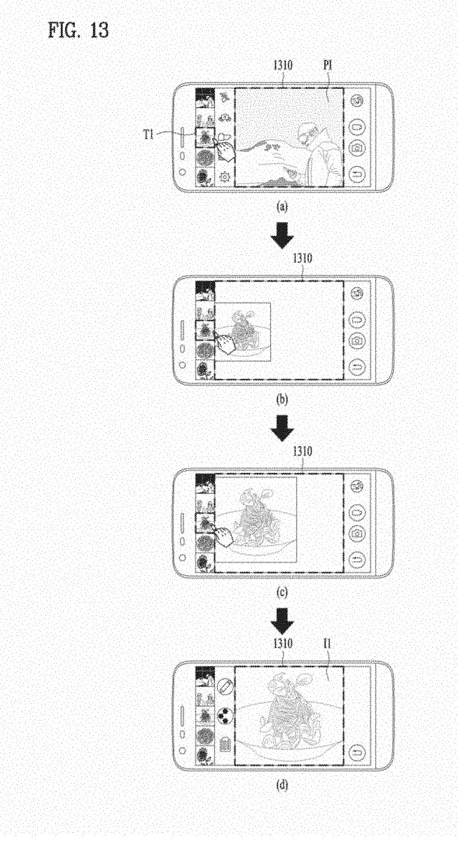

The controller 180 may provide the procedure of displaying the first image I1 corresponding to the first thumbnail image T1 instead of the preview image on the first area 1110 in accordance with the command for selecting the first thumbnail image Ti by using an animation effect. This will be described in detail with reference to FIG. 13.

Meanwhile, the controller 180 may recognize that the first thumbnail image is selected in accordance with a touch input for dragging (or flicking) the area 1121 on which the first thumbnail image T1 is displayed to the first area 1110 after touching the area 1121 at a predetermined pressure or a predetermined time.

In more detail, referring to (a) of FIG. 12, the controller 180 may enable a drag function of the first thumbnail image in accordance with a first touch input for touching the area 1121, on which the first thumbnail image T1 is displayed, at a predetermined pressure or a predetermined time. In this case, the drag function means that a second thumbnail image corresponding to the first thumbnail image is generated in accordance with the touch input of the user and a position where the generated second thumbnail image is displayed is changed depending on a change of a point where the touch input is sensed.

In this case, the first image corresponding to the first thumbnail image T1 is not displayed on the execution screen by the first touch input only. Therefore, if the first touch input is sensed and then released soon, no task is not performed, and the drag function is disabled.

Meanwhile, referring to (b) of FIG. 12, the controller 180 may sense a second touch input for dragging (or flicking) the first touch input toward a specific direction after sensing the first touch input. In this case, it is recognized that the drag function is enabled, the controller 180 may control the display unit 151 to display the second thumbnail image T2 at a position corresponding to the point where the second touch input is sensed. In this case, the second thumbnail image T2 may be a thumbnail image more enlarged than the first thumbnail image Ti as much as a predetermined level (for example, 10%).

Meanwhile, if the second touch input is released on the first area 1110, the controller 180 may control the display unit 151 to display the first image corresponding to the first thumbnail image T1 instead of the preview image PI on the first area 1110 as shown in (c) of FIG. 12.

FIG. 13 is a view illustrating an animation effect provided when an image corresponding to a thumbnail image selected instead of a preview image is displayed in a mobile terminal according to one embodiment of the present invention. Repeated description of the description made with reference to FIGS. 5 to 12 will be omitted in FIG. 13, and the example of FIG. 13 will be described based on a difference from FIGS. 5 to 12.

Referring to (a) of FIG. 13, in a state that a preview image PI acquired through the camera is displayed on a first area 1310 within an execution screen of the camera application, the controller 180 may control the display unit 151 to display a plurality of thumbnail images respectively corresponding to a plurality of images stored in the memory 170 on a partial area within the execution screen.

The controller 180 may sense a touch input for selecting a first thumbnail image T1 among the plurality of thumbnail images displayed on the partial area. For example, the touch input may be a touch input for touching an area, on which the first thumbnail image T1 is displayed, at a predetermined pressure for a predetermined time or more.

The controller 180 may control the display unit 151 to allow the preview image to disappear from the first area 1310 in accordance with the touch input for touching the first thumbnail image at a predetermined pressure for a predetermined time or more. If the touch input is maintained, the controller 180 may control the display unit 151 to display the first image corresponding to the first thumbnail image on the first area 1310.

In this case, the controller 180 may provide an animation effect. In this case, the animation effect may mean that the size of the first image which is displayed becomes great if the time for touching the first thumbnail image becomes longer.

Referring to (b) of FIG. 13, if the touch input is maintained for a first time, the controller 180 may control the display unit 151 to display the first image having the size corresponding to the first time on the first area 1310.

Referring to (c) of FIG. 13, if the touch input is maintained for a second time longer than the first time, the controller 180 may control the display unit 151 to display the first image having the size corresponding to the second time on the first area 1310.

In this case, the size corresponding to the first time may be shorter than the size corresponding to the second time. This is because that the first time is shorter than the second time. That is, the size of the first image may be changed in proportional to the time when the touch input is sensed.

Referring to (d) of FIG. 13, if the touch input sensed on the first thumbnail image is released, the controller 180 may control the display unit 151 to display the first image I1 instead of the preview image PI on the first area 1310 of the execution screen.

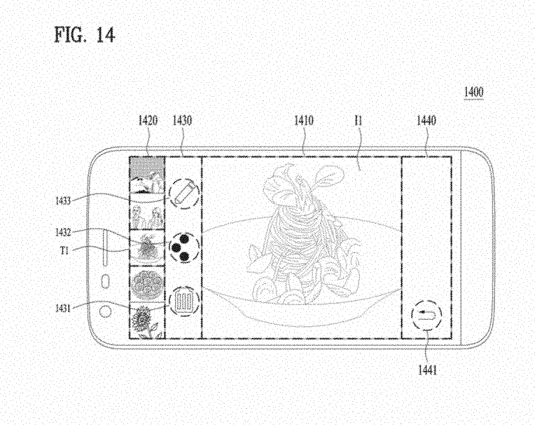

According to one embodiment of the present invention, the controller 180 may control the display unit 1510 to allow the execution screen of the camera application to be changed in accordance with an input for selecting a specific one of the plurality of thumbnail images displayed on the execution screen of the camera application. This will be described in more detail with reference to FIGS. 14 to 16.

FIG. 14 is a view illustrating an example of a method for changing an execution screen of a camera application in accordance with a command for selecting a specific thumbnail image displayed on the execution screen of the camera application in a mobile terminal according to one embodiment of the present invention. Repeated description of the description made with reference to FIGS. 5 to 13 will be omitted in FIG. 14, and the example of FIG. 14 will be described based on a difference from FIGS. 5 to 13.

Referring to FIG. 14, the controller 180 may display a plurality of thumbnail images on a second area 1420 within an execution screen 1400 of the camera application. In accordance with an input for selecting a first thumbnail image among the plurality of thumbnail images, the controller 180 may control the display unit 151 to display the first image I1 corresponding to the first thumbnail image on the first area 1410 within the execution screen.

In this case, the controller 180 may control the display unit 151 to display an indicator corresponding to a process function of the first image I1 instead of the indicator corresponding to functions of the camera application of (a) of FIG. 6 on a third area 1430.

The indicator corresponding to the process function of the first image I1 may include at least one of a first indicator 1431 corresponding to a function of deleting the first image I1, a second indicator 1432 corresponding to a function of sharing the first image, and a third indicator 1433 corresponding to a function of displaying an editing screen of the first image I1.

That is, the controller 180 may control the display unit 151 to display at least one of the first indicator 1431, the second indicator 1432 and the third indicator 1433 on the third area 1430.

Meanwhile, the controller 180 may control the display unit 151 to display an indicator 1441 corresponding to a function of returning to a previous task on a fourth area 1440 within the execution screen.

Meanwhile, according to one embodiment of the present invention, the controller 180 may display the preview image on a partial area of the execution screen of the camera application when displaying the first image instead of the preview image on the execution screen of the camera application.

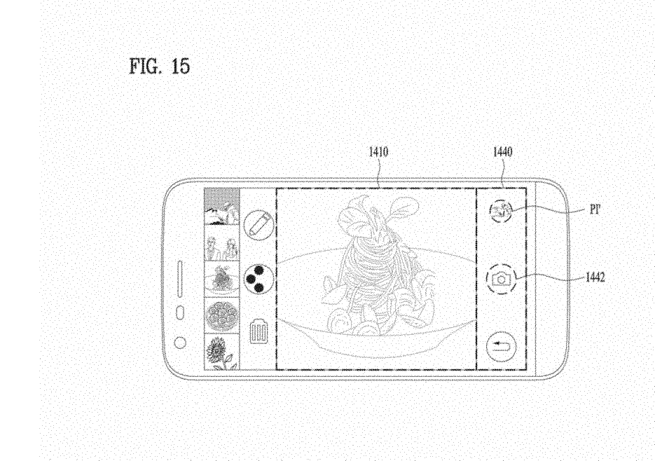

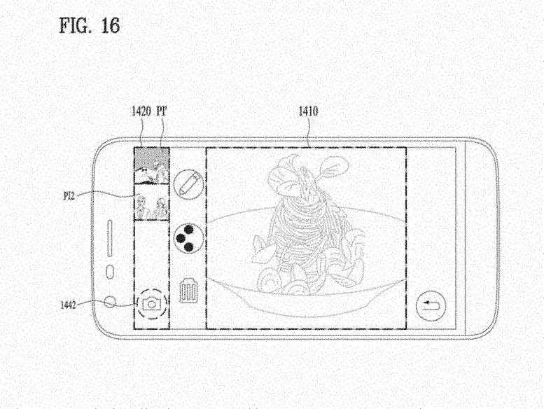

FIGS. 15 and 16 are views illustrating an example of a method for displaying a preview image acquired through a camera when an image corresponding to a specific thumbnail image is displayed on an execution screen of a camera application in a mobile terminal according to one embodiment of the present invention. Repeated description of the description made with reference to FIGS. 5 to 14 will be omitted in FIGS. 15 and 16, and the example of FIGS. 15 and 16 will be described based on a difference from FIGS. 5 to 14.

According to one embodiment of the present invention, in accordance with an input for selecting a specific thumbnail image displayed on the execution screen of the camera application, the controller 180 may control the display unit to display a first image corresponding to the specific thumbnail image on the first area 1410 within the execution screen of the camera application. In this case, the controller 180 may control the display unit 151 to display the preview image displayed on the camera application on one area within the execution screen.

For example, referring to FIG. 15, when the first image instead of the preview image is displayed on the first area 1410, the controller 180 may change the size of the preview image. The controller 180 may control the display unit 151 to display the preview image PI′ of which size is changed on one area within the fourth area 1440. In this case, the controller may control the display unit 151 to display an indicator 1442 corresponding to an image capturing command on the fourth area 1440 together with the preview image PI′.

For another example, referring to FIG. 16, when the first image instead of the preview image is displayed on the first area 1410, the controller 180 may change the size of the preview image. The controller 180 may control the display unit 151 to display the preview image PI′ of which size is changed on the second area 1420 on which the plurality of thumbnail images are displayed. In this case, the plurality of thumbnail images displayed on the second area 1420 may disappear from the second area 1420. Also, the controller 180 may control the display unit 151 to display the indicator 1442 corresponding to the image capturing command on the second area 1420 together with the preview image PI′.

Meanwhile, in accordance with the embodiment, the controller 180 may control the display unit 151 to display the preview images acquired through all the cameras provided in the mobile terminal on the second area 1420.

For example, the controller 180 may control the display unit 151 to display a first preview image PI′ acquired through a rear camera and a second preview image PI2 acquired through a front camera on the second area 1420.

According to this embodiment, the user may take an image while identifying the images stored in the memory 170.

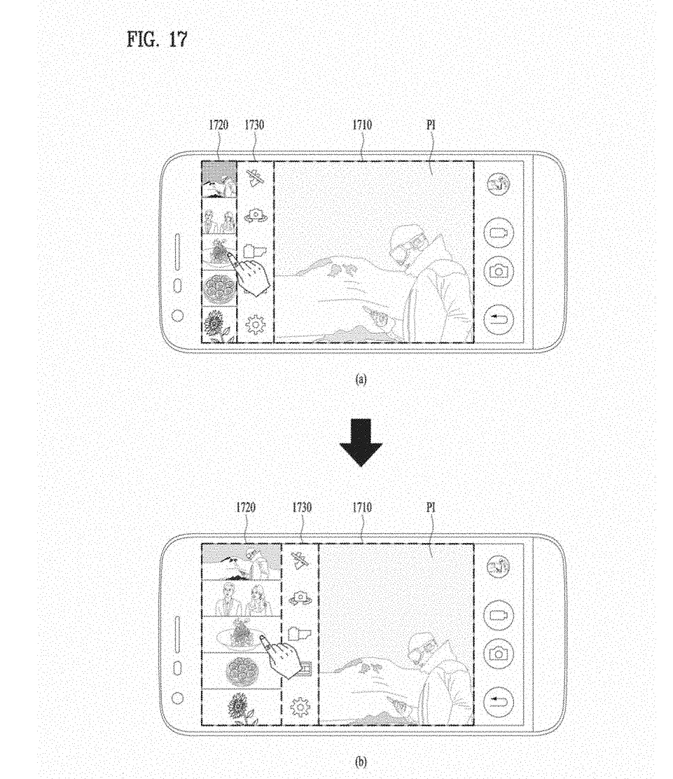

Meanwhile, according to one embodiment of the present invention, the controller 180 may change the size of the area on which the plurality of thumbnail images corresponding to the plurality of images stored in the memory are displayed. This will be described in more detail with reference to FIG. 17.

FIG. 17 is a view illustrating an example of a method for changing a size of an area on which a plurality of thumbnail images are displayed in a mobile terminal according to one embodiment of the present invention. Repeated description of the description made with reference to FIGS. 5 to 16 will be omitted in FIG. 17, and the example of FIG. 17 will be described based on a difference from FIGS. 5 to 16.

Referring to (a) of FIG. 17, the controller 180 may control the display unit 151 to display a preview image PI acquired through the camera 121 on a first area 1710 within an execution screen of the camera application. The controller 180 may control the display unit 151 to display a plurality of preview images corresponding to a plurality of images stored in the memory 170 on a second area 1720 within the execution screen.

Meanwhile, the controller 180 may change the size of the second area 1720 as shown in (b) of FIG. 17 in accordance with a touch input for touching one point within the second area 1720 at a predetermined pressure for a predetermined time. In this case, the size of the second area 1720 may be increased in proportional to the time when the touch input is sensed.

In this case, the size of the preview image which is being displayed on the execution screen may be changed. In more detail, as the size of the second area 1720 is changed to become great, the size of the first area 1710 may be changed to become small as shown in (b) of FIG. 17. Therefore, the size of the preview image PI displayed on the first area 1710 may be changed to become small.

Also, referring to (a) of FIG. 17 and (b) of FIG. 17, as the size of the second area 1720 is changed, a position of a third area 1730 on which the indicator corresponding to functions of the camera application is displayed may be changed.

Meanwhile, the controller 180 may maintain the state that the sizes of the first area 1710 and the second area 1720 are changed, even in the case that the touch input is released. However, without limitation to this case, the controller 180 may again change the sizes of the first and second areas 1710 and 1720 to their original sizes as shown in (a) of FIG. 17 as the touch input is released.

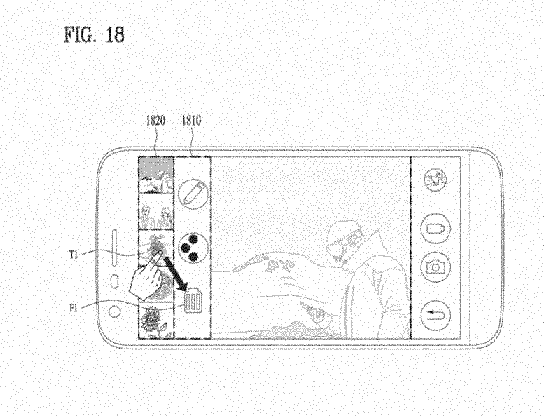

Meanwhile, according to one embodiment of the present invention, the user may edit, share or delete the images stored in the memory by using the thumbnail image displayed on one area of the execution screen of the camera application. This will be described in more detail with reference to FIGS. 18 to 21.

FIGS. 18 to 20 are views illustrating an example of a method for processing images stored in a memory in a mobile terminal according to one embodiment of the present invention. Repeated description of the description made with reference to FIGS. 5 to 17 will be omitted in FIGS. 18 to 20, and the example of FIGS. 18 to 20 will be described based on a difference from FIGS. 5 to 17.

According to one embodiment of the present invention, the controller 180 may control the display unit 151 to display a plurality of thumbnail images respectively corresponding to a plurality of images stored in the memory on a second area 1820 of an execution screen of the camera application.

Meanwhile, in accordance with a touch input for touching a first thumbnail image Ti among the plurality of thumbnail images displayed on the second area 1820, the controller 180 may control the display unit 151 to display an indicator corresponding to a process function of a first image corresponding to the first thumbnail image Ti on a third area 1830 within the execution screen.

In this case, the indicator corresponding to the process function of the first image may be displayed on the third area 1830 instead of the indicator corresponding to functions of the camera application.

The indicator corresponding to the process function of the first image may include at least one of a first indicator corresponding to a function of deleting the first image, a second indicator corresponding to a function of sharing the first image, and a third indicator corresponding to a function of displaying an editing screen of the first image.

Referring to FIG. 18, the controller 180 may sense a first touch input for dragging the first thumbnail image Ti to an area on which the first indicator F1 corresponding to the function of deleting the first image is displayed after touching the first thumbnail image Ti. The controller 180 may delete the first image from the memory in accordance with the first touch input.

In accordance with the embodiment, the controller 180 may additionally display a window for identifying whether to delete the first image, in accordance with the first touch input. Also, the controller 180 may delete the first image from the memory 170 as far as a command to delete the first image is sensed through the displayed window.

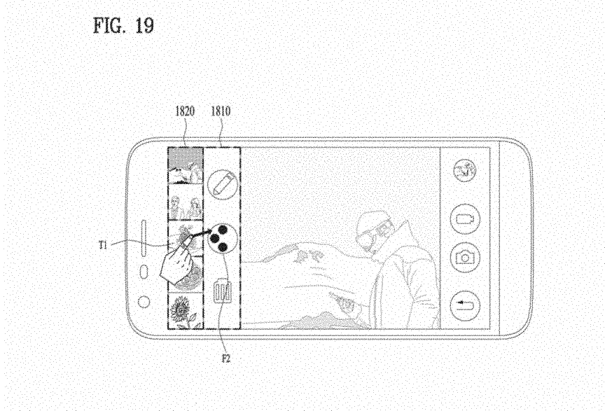

Referring to FIG. 19, the controller 180 may sense a second touch input for dragging the first thumbnail image Ti to an area on which the second indicator F2 corresponding to the function of sharing the first image is displayed after touching the first thumbnail image Ti. The controller 180 may share the first image with an external device or an external server in accordance with the second touch input.

In more detail, the controller 180 may control the display unit to display a window for sharing of the first image in accordance with the second touch input. Also, the controller 180 may share the first image with the external device or the external server when sensing the command to share the first image with the external device or the external server through the window.

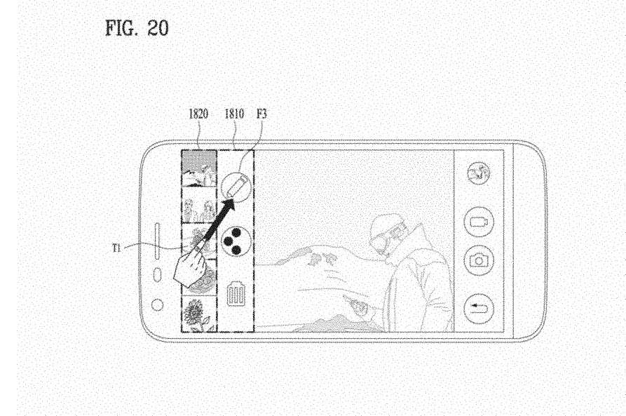

Referring to FIG. 20, the controller 180 may sense a third touch input for dragging the first thumbnail image Ti to the third indicator F3 corresponding to the function of displaying the editing screen of the first image after touching the first thumbnail image T1. The controller 180 may control the display unit 151 to display a screen for performing an editing function of the first image in accordance with the third touch input.

In this case, the controller 180 may display the screen for performing an editing function of the first image on the first area on which the preview image acquired through the camera is displayed within the execution screen of the camera application. In this case, instead of the preview image, the screen for performing the editing function of the first image is displayed on the first area.

In more detail, the controller 180 may control the display unit 151 to execute an application for performing the editing function of the first image and then display an execution screen of the executed application on the first area.

According to the aforementioned embodiment, it is advantageous that the user may delete, share or edit any one of the plurality of images stored in the memory in the middle of taking an image through the camera.

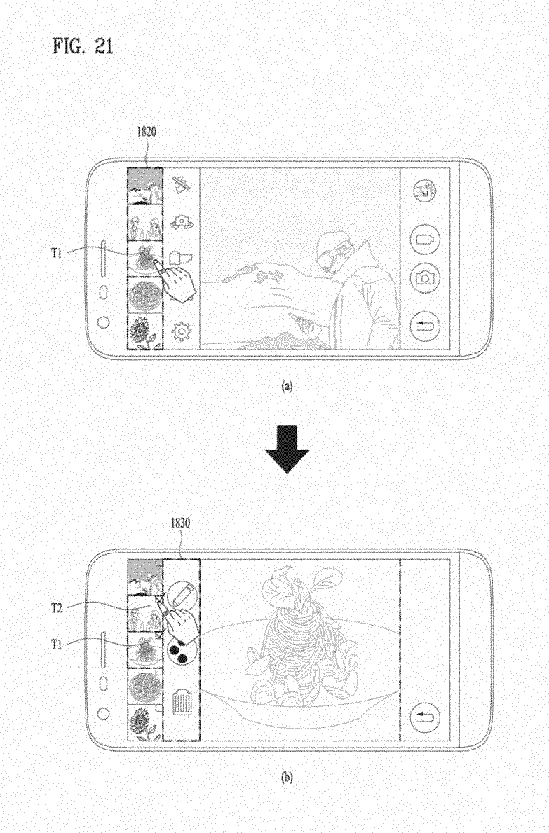

Meanwhile, according to one embodiment of the present invention, the plurality of images stored in the memory may be processed together using the thumbnail image displayed on the execution screen of the camera application. This will be described in more detail with reference to FIG. 21.

FIG. 21 is a view illustrating an example of a method for processing a plurality of images stored in a memory by using an execution screen of a camera application in a mobile terminal according to one embodiment of the present invention. Repeated description of the description made with reference to FIGS. 5 to 20 will be omitted in FIG. 21, and the example of FIG. 21 will be described based on a difference from FIGS. 5 to 20.

Referring to (a) of FIG. 21, the controller 180 may sense a fourth touch input for touching any one of a plurality of thumbnail images, which are displayed on a second area 1820 within an execution screen of a camera application, for a predetermined time or more.

Referring to (b) of FIG. 21, the controller 180 may control the display unit 151 to display a check box on each of the plurality of thumbnail images in accordance with the fourth touch input. In accordance with a touch input for touching the displayed check box, the controller 180 may control the display unit 151 to display a check mark on the check box in which the touch input is sensed. That is, the controller 180 may control the display unit 151 to display the check mark on the check box corresponding to an image selected by the user among the displayed check boxes.

If the user senses a touch command for selecting any one of indicators corresponding to a first image process function displayed on a third area 1830 within the execution screen of the camera application after completing the check mark, the user may perform a function of the indicator corresponding to the touch command.

For example, the user may touch an indicator corresponding to a function of deleting an image after selecting a first thumbnail image Ti and a second thumbnail image T2 among the plurality of thumbnail images displayed on the second area 1820. In this case, the controller 180 may delete an image corresponding to each of the first thumbnail image Ti and the second thumbnail image T2 from the memory 170 in accordance with the touch input.

For another example, the user may touch an indicator corresponding to a function of sharing an image after selecting the first thumbnail image Ti and the second thumbnail image T2 among the plurality of thumbnail images displayed on the second area 1820. In this case, the controller 180 may share the image corresponding to each of the first thumbnail image Ti and the second thumbnail image T2 with an external device or an external server.

For still another example, the user may touch an indicator corresponding to a function of displaying an editing screen of an image after selecting the first thumbnail image T1 and the second thumbnail image T2 among the plurality of thumbnail images displayed on the second area 1820. In this case, the controller 180 may control the display unit 151 to display the editing screen of the image corresponding to each of the first thumbnail image T1 and the second thumbnail image T2 in accordance with the touch input.

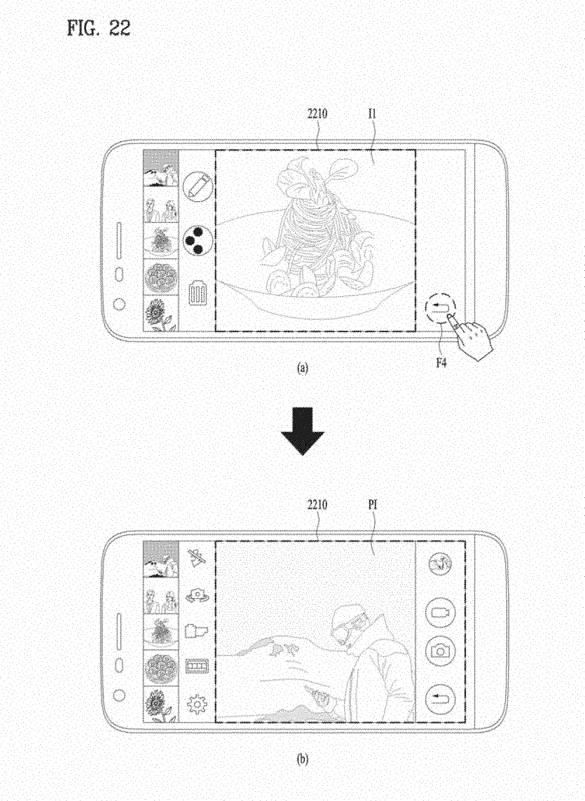

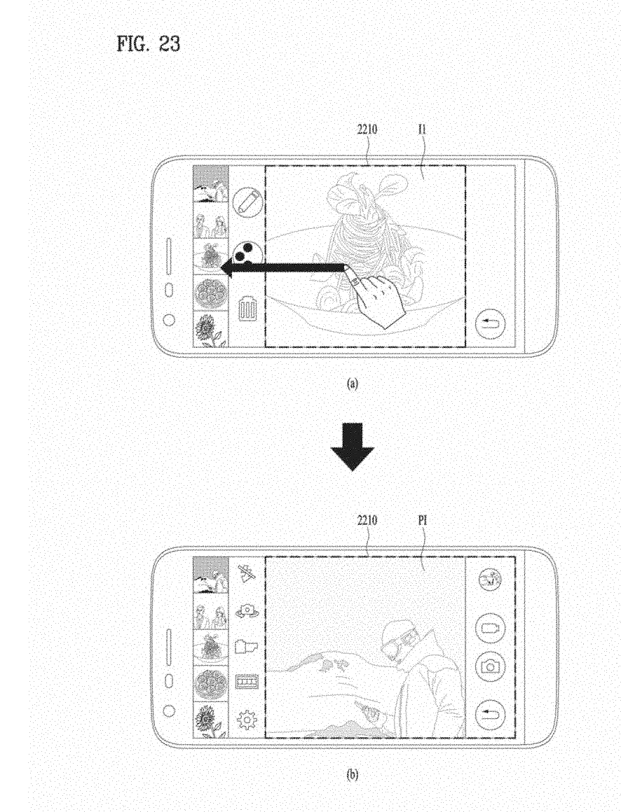

Meanwhile, according to one embodiment of the present invention, in a state that the images stored in the memory are displayed on the execution screen of the camera application, the controller 180 may control the display unit 151 to again display a preview image in accordance with a specific input. This will be described in more detail with reference to FIGS. 22 and 23.

FIGS. 22 and 23 are views illustrating an example of a method for displaying a preview image in a state that images stored in a memory are displayed on an execution screen of a camera application in a mobile terminal according to one embodiment of the present invention. Repeated description of the description made with reference to FIGS. 5 to 21 will be omitted in FIGS. 22 and 23, and the example of FIGS. 22 and 23 will be described based on a difference from FIGS. 5 to 21.

According to one embodiment of the present invention, the controller 180 may control the display unit 151 to display a preview image acquired through the camera on a first area of an execution screen of the camera application and display a plurality of thumbnail images corresponding to a plurality of images stored in the memory on a second area of the execution screen. In accordance with a command to select a first thumbnail iamge among the plurality of thumbnail images displayed on the second area, the controller 180 may control the display unit 151 to display a first image corresponding to the first thumbnail image on the first area.

If a specific input is sensed in a state that the first image is displayed on the first area 2210, the controller 180 may control the display unit 151 to display the preview image PI instead of the first image I1 on the first area 2210.

For example, referring to (a) of FIG. 22, the controller 180 may control the display unit 151 to again display the preview image PI on the first area 2210 as shown in (b) of FIG. 22 in accordance with a touch input for touching a specific indicator F4 for executing a reverse function, displayed on the execution screen.

For another example, referring to (a) of FIG. 23, the controller 180 may control the display unit 151 to again display the preview image PI on the first area 2210 as shown in (b) of FIG. 23 in accordance with a touch input for dragging or flicking the first area 2210 on which the first image I1 is displayed on the execution screen, toward the second area after touching the first area 2210.

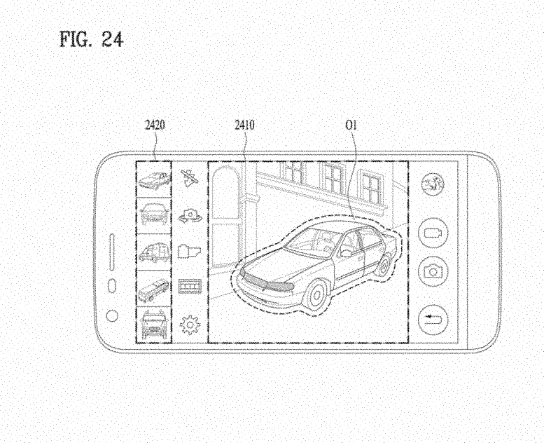

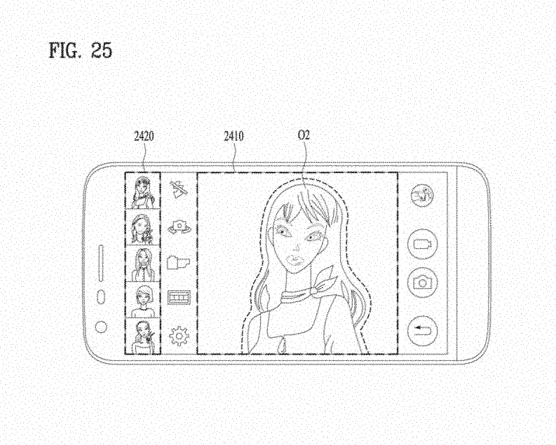

Meanwhile, according to the present invention, the controller 180 may recognize an object included in the preview image acquired through the camera, extract an image, which includes an object corresponding to the recognized object, from the memory 170, and display the extracted image on the execution screen of the camera application. This will be described in more detail with reference to FIGS. 24 and 25.

FIGS. 24 and 25 are views illustrating an example of a method for extracting an image including an object corresponding to an object included in a preview image and displaying a thumbnail image corresponding to the extracted image in a mobile terminal according to one embodiment of the present invention.

According to one embodiment of the present invention, the controller 180 may control the display unit to display an image acquired through the camera on a first area 2410 within an execution screen of the camera application. The controller 180 may recognize the object included in the preview image displayed on the first area 2410. The controller may control the display unit 151 to extract an image, which includes an object corresponding to the recognized object, among a plurality of images stored in the memory 170 and display a thumbnail image corresponding to the extracted image on a second area 2420 within the execution screen.

For example, referring to FIG. 24, the controller 180 may recognize that an object 01 included in the preview image displayed on the first area 2410 is a car. In this case, the controller 180 may extract an image, which includes a car, from the plurality of images stored in the memory 170. The controller 180 may control the display unit 151 to display a plurality of thumbnail images respectively corresponding to a plurality of images, which include the extracted car, on the second area 2420.

For another example, referring to FIG. 25, if it is recognized that an object 02 included in the preview image displayed on the first area 2410 is a person, the controller 180 may recognize a face of the person by using a face recognition algorithm. The controller 180 may extract an image, which includes the recognized face, from the plurality of images stored in the memory 170. Also, the controller 180 may control the display unit 151 to display a thumbnail image corresponding to the extracted image on the second area 2420.

According to at least one of the aforementioned embodiments of the present invention, it is advantageous that the user may identify the plurality of images stored in the memory simultaneously with taking an image. Also, according to at least one of the aforementioned embodiments of the present invention, it is advantageous that the user may easily follow a composition of an image of a specialist or a well-taken image even though the user is not a photo specialist.

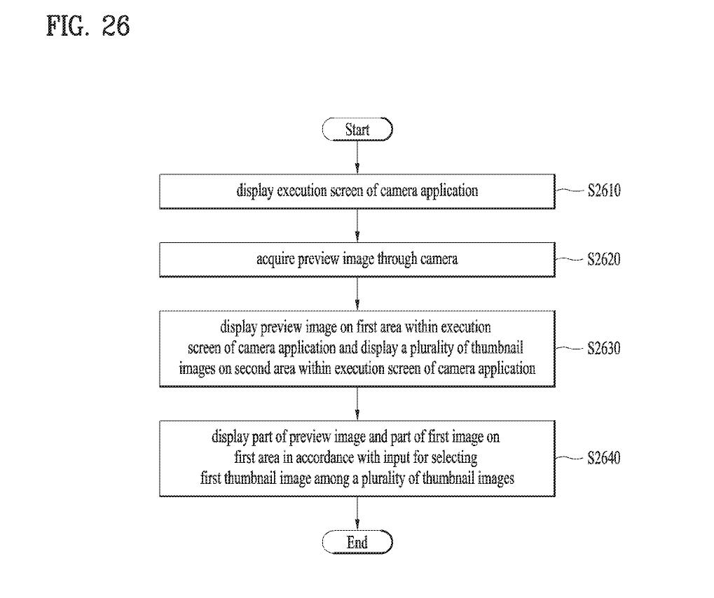

Meanwhile, users who desire to take an image in various manners are recently increasing. Particularly, users who desire to take an image having the same composition as that of an image taken previously and edit the images in one image are increasing. However, a technique of using images stored in the memory 170 when taking an image does not exist in the related art. Therefore, a method for taking an image by using images stored in the memory 170 in a mobile terminal according to one embodiment of the present invention will be described with reference to FIGS. 26 to 38.

FIG. 26 is a flow chart illustrating an example of a method for using images stored in a memory when taking an image in a mobile terminal according to one embodiment of the present invention.

According to one embodiment of the present invention, the memory 170 may store a plurality of images therein. In this case, the plurality of images may include images acquired through the camera, images acquired through capturing, images received from an external server or an external device, etc.

However, without limitation to this case, images may not be stored in the memory 170, or only one image may be stored in the memory 170. For convenience of description, it is assumed that a plurality of images are stored in the memory 170. The embodiments which will be described hereinafter may be applied to even the case that one image is stored in the memory 170 or the case that no image is stored therein.

The camera application may be stored in the memory 170. The camera application may be stored in the memory 170 from the release timing, may be installed during upgrade of an application program or firmware, or may separately be stored in the memory 170 by the user.

The controller 180 may control the display unit 151 to display the execution screen of the camera application in accordance with an execution command of the camera application (S2610).

Meanwhile, the controller 180 may enable the camera 121 in accordance with the execution command of the camera application. The enabled camera 121 may acquire a preview image (S2620). The preview image means an image acquired through the camera in real time.

The controller 180 may control the display unit 151 to display the preview image acquired through the enabled camera and a plurality of thumbnail images respectively corresponding to the plurality of images stored in the memory 170 on the execution screen.

In more detail, the controller 180 may control the display unit 151 to display the preview image on a first area within the execution screen of the camera application and display the plurality of thumbnail images on a second area within the execution screen (S2630). In this case, the first area and the second area may be those different from each other.

Meanwhile, in accordance with an input for selecting a first thumbnail image among the plurality of thumbnail images displayed on the second area, the controller 180 may control the display unit 151 to display a part of the preview image and display a part of a first image corresponding to the first thumbnail image on the first area within the execution screen (S2640).

In more detail, in accordance with the input for selecting the first thumbnail image, the controller 180 may split the first area into a third area and a fourth area. Also, the controller 180 may control the display unit 151 to display the part of the first image corresponding to the third area on the third area and display the part of the preview image corresponding to the fourth area on the fourth area.

Meanwhile, according to one embodiment of the present invention, the controller 180 may acquire a part of the first image and a part of the preview image as one image. The controller 180 may store the acquired image in the memory 170.

However, without limitation to this case, the controller 180 may separately store the preview image acquired through the camera in the memory 170 in accordance with the image capturing command in addition to the acquired one image. That is, full images captured through the camera may be stored in the memory together with the acquired one image.

According to this embodiment, it is advantageous that the user may perform split capturing of various images according to a recent trend. Also, it is advantageous that the user may easily follow a composition of an image of a specialist or a well-taken image even though the user is not a photo specialist.

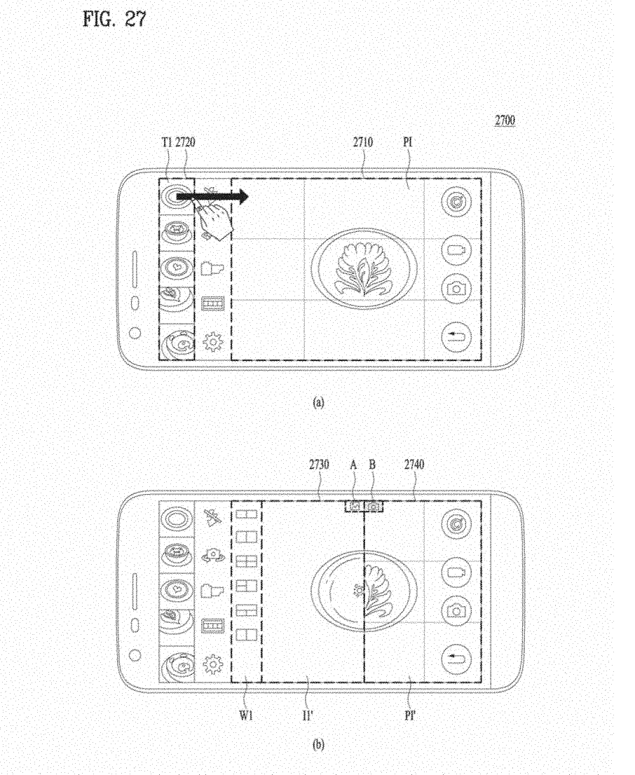

FIG. 27 is a view illustrating an example of a method for using images stored in a memory when taking an image in a mobile terminal according to one embodiment of the present invention.

According to one embodiment of the present invention, the controller 180 may control the display unit to display an execution screen of the camera application.

In respect of FIG. 27, it is assumed that the mobile terminal 100 is a horizontal mode. In this case, the horizontal mode may mean the state that a top end of the mobile terminal is headed for a left side or a right side, or may mean the state that the top end of the mobile terminal is not headed for a downward side or an upward side.

Referring to (a) of FIG. 27, the controller 180 may control the display unit 151 to display a preview image PI acquired through the camera on a first area 2710 within the execution screen.

The controller 180 may control the display unit 151 to display a plurality of thumbnail images corresponding to a plurality of images stored in the memory 170 on a second area 2720 within the execution screen. However, without limitation to this, the plurality of thumbnail images may be displayed on the preview image PI.

Meanwhile, since the size of the display unit 151 is limited, all of the plurality of thumbnail images stored in the memory 170 cannot be displayed on the second area 2720. Therefore, the controller 180 may control the display unit 151 to display the thumbnail images in accordance with a certain order.

For example, the controller 180 may control the display unit 151 to sequentially display the plurality of thumbnail images on the second area 2720 on the basis of a photo session of each of the plurality of images stored in the memory 170.

In more detail, the controller 180 may control the display unit 151 to display a first thumbnail image Ti corresponding to the most recently captured image on the uppermost end within the second area 2720. Also, the controller 180 may control the display unit 151 to display the plurality of thumbnail images respectively corresponding to the plurality of images stored in the memory 170 below the first thumbnail image in accordance with a time order.

For another example, the controller 180 may control the display unit 151 to sequentially display the plurality of thumbnail images on the basis of a use frequency.

In this case, the use frequency may mean a level selected by the user. For example, the image having a high use frequency may be an image selected most frequently by the user.

In more detail, the controller 180 may control the display unit 151 to display the first thumbnail image Ti corresponding to the most frequently used image on the uppermost end within the second area 2720. Also, the controller 180 may control the display unit 151 to display the plurality of thumbnail images respectively corresponding to the plurality of images stored in the memory 170 below the thumbnail image Ti corresponding to the most frequently used image in accordance with a use frequency.

Meanwhile, according to one embodiment of the present invention, the controller 180 may control the display unit 151 to display the plurality of thumbnail images corresponding to images located in a specific folder among the plurality of images stored in the memory 170 on the second area 2720. In this case, the specific folder may be a folder selected by the user.

The controller 180 may control the display unit 151 to display a part IF of the first image corresponding to the first thumbnail image and a part PI′ of the preview image on the first area in accordance with a first input for selecting the first thumbnail image among the plurality of thumbnail images displayed on the second area 2720 within the execution screen 2700.

In this case, the first input may be a touch input for dragging the first thumbnail image T1 toward the first area 2710 after touching the first thumbnail image T1 at a predetermined pressure for a predetermined time. However, without limitation to this, the first input may include a touch input for touching the first thumbnail image T1 at a predetermined pressure, a touch input for touching the first thumbnail image Ti for a predetermined time, etc.

Referring to (b) of FIG. 27, in accordance with the first input, the controller 180 may control the display unit 151 to display a part I1′ of the first image corresponding to the first thumbnail image on a third area 2730 and display a part PI′ of the preview image on a fourth area 2740.

In more detail, in accordance with the first input, the controller 180 may split the first area 2710 into the third area 2730 and the fourth area 2740 as shown in (b) of FIG. 27. Also, the controller 180 may control the display unit 151 to display the part I1′ of the first image on the third area 2730 and display the part PI′ of the preview image on the fourth area 2740.

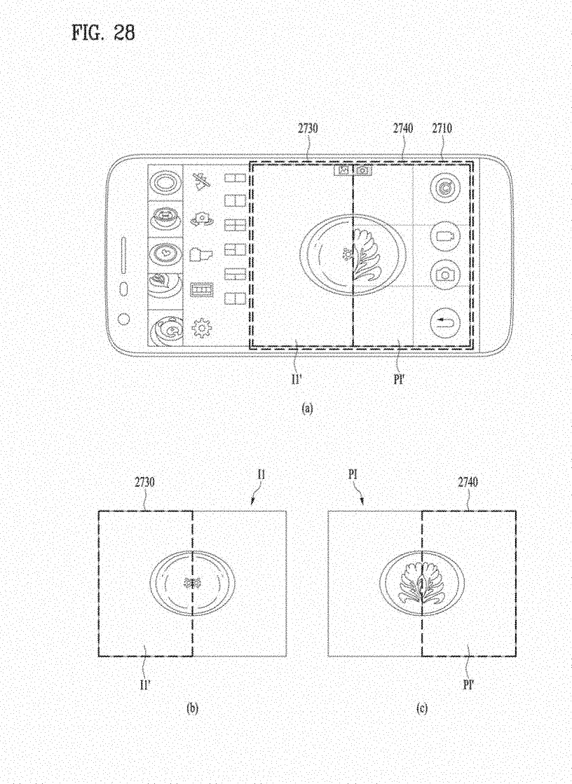

In this case, the part I1′ of the first image displayed on the third area 2730 may be a part corresponding to the third area 2730 within the first image corresponding to the first thumbnail image T1. The part P1′ of the preview image displayed on the fourth area 2740 may be a part corresponding to the fourth area 2740 within the preview image PI. This will be described in more detail with reference to FIG. 28.

However, without limitation to this case, the controller may control the display unit 151 to display the part PI′ of the preview image on the third area 2730 and display the part IF of the first image on the fourth area 2740. In this case, the part PI′ of the preview image may be a part corresponding to the third area 2730 within the preview image, and the part IF of the first image may be a part corresponding to the fourth area 2740 within the first image.

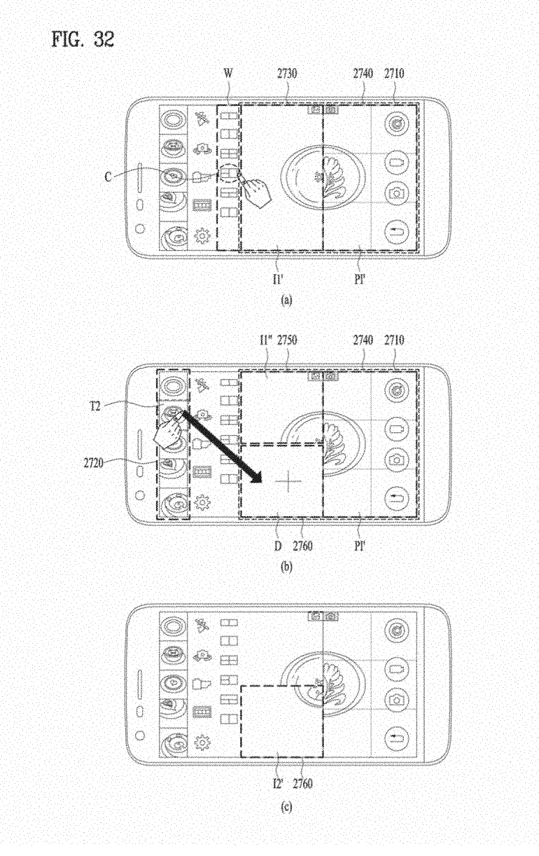

Meanwhile, the controller 180 may control the display unit 151 to display a window W1 related to split setup of the first area 2710 on the execution screen 2700. The controller 180 may change split setup of the first area 2710 in accordance with an input for selecting any one of a plurality of indicators displayed on the window W1. This will be described in more detail with reference to FIG. 32.

Meanwhile, the controller 180 may control the display unit 151 to display indicators A and B indicating that the image displayed on the third area 2730 or the fourth area 2740 is the part PI′ of the preview image or the part I1′ of the first image.

The controller 180 may control the display unit 151 to display the first indicator A, which indicates that the part IF of the first image is displayed on the third area 2730, on the third area 2730.

The controller 180 may control the display unit 151 to display the second indicator B, which indicates that the part PI′ of the preview image is displayed on the fourth area 2740, on the fourth area 2740.

The user may identify whether the images displayed on the third area 2730 and the fourth area 2740 are the preview images or the images stored in the memory, by identifying the first indicator A and the second indicator B

Meanwhile, the controller 180 may acquire the part IF of the first image and the part PI′ of the preview image as one image in accordance with an input for taking an image. The controller 180 may store the acquired image in the memory 170. This will be described in more detail with reference to FIG. 28.

FIG. 28 is a view illustrating an example of a method for displaying an image selected by a user and an image taken through a camera together in a mobile terminal according to one embodiment of the present invention. Repeated description of the description made with reference to FIG. 27 will be omitted in FIG. 28, and the example of FIG. 28 will be described based on a difference from FIG. 27.

In respect of FIG. 28, it is assumed that a first image I1 corresponding to a first thumbnail image is selected in accordance with a first input for selecting the first thumbnail image and a preview image PI is acquired through the camera.

Referring to (a) of FIG. 28, the controller 180 may control the display unit 151 to display a part IF of the first image and a part PI′ of the preview image PI on a first area 2710 within an execution screen of a camera application in accordance with the first input.

In more detail, the controller 180 may split the second area 2720 into a third area 2730 and a fourth area 2740 in accordance with the first input.

For example, the controller 180 may split the second area 2720 into halves and set a right side to a third area 2730 and a left side to a fourth area 2740.

However, without limitation to this example, the second area 2720 may be split in various methods.

If the second area 2720 is split into the third area 2730 and the fourth area 2740, the controller 180 may control the display unit 151 to display a part IF of the first image I1 on the third area 2730 and display a part PI′ of the preview image PI on the fourth area 2740.

First of all, the part IF of the first image I1 displayed on the third area 2730 will be described as follows.

Referring to (b) of FIG. 28, the controller 180 may control the display unit 151 to display the part IF of the first image, which corresponds to the third area 2730 within the first image I1, on the third area 2730.

For example, the controller 180 may crop the first image I1 as much as the third area 2730. In this case, the term ‘crop’ means that the first image I1 is cut as much as the third area 2730. The controller 180 may control the display unit 151 to display the cropped first image I1′ on the third area 2730.

For another example, the controller 180 may control the display unit 151 to display only a part corresponding to the third area 2730 within the first image I1. That is, when displaying the first image I1, the controller 180 may control the display unit 151 to display only the part corresponding to the third area 2730 on the third area 2730.

Next, the part PI′ of the preview image PI displayed on the fourth area 2740 will be described as follows.

Referring to (c) of FIG. 28, the controller 180 may control the display unit 151 to display the part PI′ of the preview image, which corresponds to the fourth area 2740 within the preview image, on the fourth area 2740.

For example, the controller 180 may crop the preview image PI as much as the fourth area 2740. In this case, the term ‘crop’ means that the preview image PI is cut as much as the fourth area 2740. The controller 180 may control the display unit 151 to display the cropped preview image PI′ on the fourth area 2740.

For another example, the controller 180 may control the display unit 151 to display only a part corresponding to the fourth area 2740 within the preview image PI. That is, when displaying the preview image PI, the controller 180 may control the display unit 151 to display only the part corresponding to the fourth area 2740 on the third area 2740.

For still another example, the controller 180 may overlap the part IF of the first image on the preview image PI. In this case, the part IF of the first image may be a part corresponding to the third area 2730 within the first image. That is, as the part IF of the first image is displayed on the preview image PI, the user may view only the part IF of the first image and the part PI′ of the preview image.

For further still another example, the controller 180 may overlap the part PI′ of the preview image on the first image I1. In this case, the part PI′ of the preview image may be a part corresponding to the fourth area 2740 within the preview image. That is, as the part PI′ of the preview image is displayed on the first image I1, the user may view only the part IF of the first image and the part PI′ of the preview image.

However, without limitation to this examples, the part Ti′ of the first image and the part PI′ of the preview image may be displayed in various methods.

Meanwhile, according to one embodiment of the present invention, the controller 180 may acquire the part IF of the first image and the part PI′ of the preview image, which are displayed on the execution screen of the camera application, as one image in accordance with an image capturing command and store the acquired image in the memory 170.

For example, the controller 180 may capture the screen on which the part IF of the first image and the part PI′ of the preview image are displayed, in accordance with the image capturing command. The controller 180 may store the captured image in the memory 170.

For another example, the controller 180 may edit the part Ti′ of the first image, which is cropped, and the part PI′ of the preview image, which is cropped, as one image in accordance with the image capturing command. The controller 180 may store the edited one image in the memory 170.

According to one embodiment of the present invention, the controller 180 may store the preview image PI acquired through the camera in the memory 170 together with the one image when storing the one image in the memory 170. The controller 180 may store only the part PI′ of the preview image acquired through the camera in the memory 170 together with the one image when storing the one image in the memory 170.

According to this embodiment, it is advantageous that an image is captured and at the same time edited automatically and then stored in the memory without being required to be separately edited by the user to generate multi-split images.

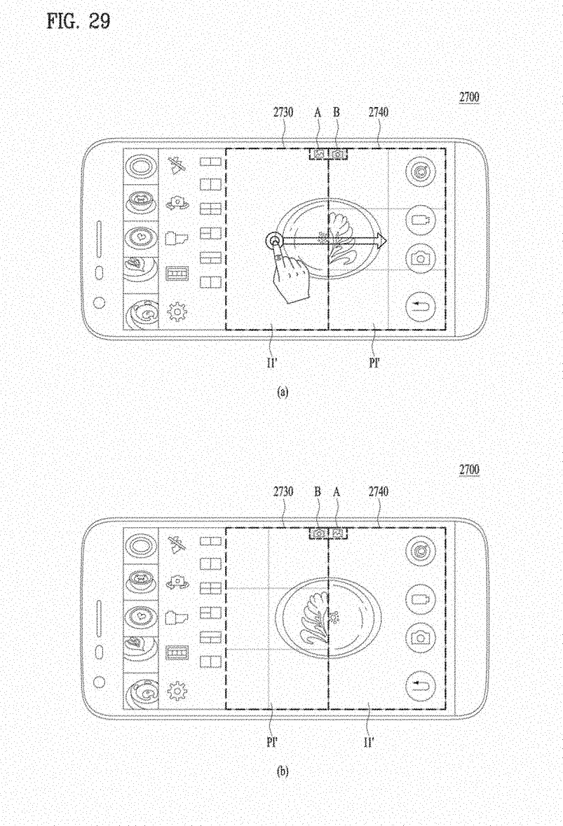

Meanwhile, according to one embodiment of the present invention, the user may control the image displayed on the execution screen of the camera application. This will be described in more detail with reference to FIGS. 29 to 31.

FIGS. 29 to 31 are views illustrating an example of a method for controlling an image displayed on an execution screen of a camera application in a mobile terminal according to one embodiment of the present invention. Repeated description of the description made with reference to FIGS. 27 and 28 will be omitted in FIGS. 29 to 31, and the example of FIGS. 29 to 31 will be described based on a difference from FIGS. 27 and 28.

Referring to (a) of FIG. 29, the controller 180 may control the display unit 151 to display a part IF of a first image corresponding to a thumbnail image selected by a user on a third area 2730 within an execution screen 2700 of a camera application and display a part PI′ of a preview image PI acquired through a camera on a fourth area 2740 within the execution screen 2700.

The controller 180 may control the display unit 151 to display a first indicator A, which indicates that the part I1′ of the first image is displayed on the third area 2730, on the third area 2730.

The controller 180 may control the display unit 151 to display a second indicator B, which indicates that the part PI′ of the preview image is displayed on the fourth area 2740, on the fourth area 2740.

Meanwhile, in accordance with a first input, the controller 180 may control the display unit 151 to display the part PI′ of the preview image on the third area 2730 and display the part I1′ of the first image on the fourth area 2740 as shown in (b) of FIG. 29.

For example, the first input may be a touch input for dragging (or flicking) one point within the third area 2730, on which the part I1′ of the first image is displayed, toward the fourth area 2740 after touching the one point within the third area 2730.

In more detail, the controller 180 may control the display unit 151 to display the part IF corresponding to the third area 2730 within the preview image on the third area 2730 in accordance with the first input. Also, the controller may control the display unit 151 to display the part PI corresponding to the fourth area 2740 within the first image on the fourth area 2740 in accordance with the first input. That is, the controller 180 may change the position on which the part of the preview image and the part of the first image are displayed, in accordance with the first input.

Meanwhile, the part I1′ of the first image displayed on the execution screen in (a) of FIG. 29 is a part corresponding to the third area 2730 within the first image, and the part I1′ of the first image displayed on the execution screen in (b) of FIG. 29 is a part corresponding to the fourth area 2740 within the first image. Therefore, the part IF of the first image in (a) of FIG. 29 and the part IF of the first image in (b) of FIG. 29 are images different from each other although the same reference numeral is given to them.

Also, the part PI′ of the preview image displayed on the execution screen in (a) of FIG. 29 is a part corresponding to the fourth area 2740 within the preview image, and the part PI′ of the preview image displayed on the execution screen in (b) of FIG. 29 is a part corresponding to the third area 2730. Therefore, the part PI′ of the preview image in (a) of FIG. 29 and the part PI′ of the preview image in (b) of FIG. 29 are images different from each other although the same reference numeral is given to them.

Meanwhile, since the areas on which the part PI′ of the preview image and the part IF of the first image are displayed have been changed in accordance with the first input, the positions on which the first indicator A and the second indicator B are displayed may be changed.

In more detail, in accordance with the first input, the controller 180 may control the display unit 151 to display the second indicator B on the third area 2730 and display the first indicator A on the fourth area 2740.

Meanwhile, according to one embodiment of the present invention, the part IF of the first image displayed on the third area 2730 may be a part corresponding to the third area 2730 within the first image I1. However, in accordance with a second input, the controller 180 may control the display unit 151 to display a part corresponding to a fifth area different from the third area 2730 within the first image I1 on the third area 2730.

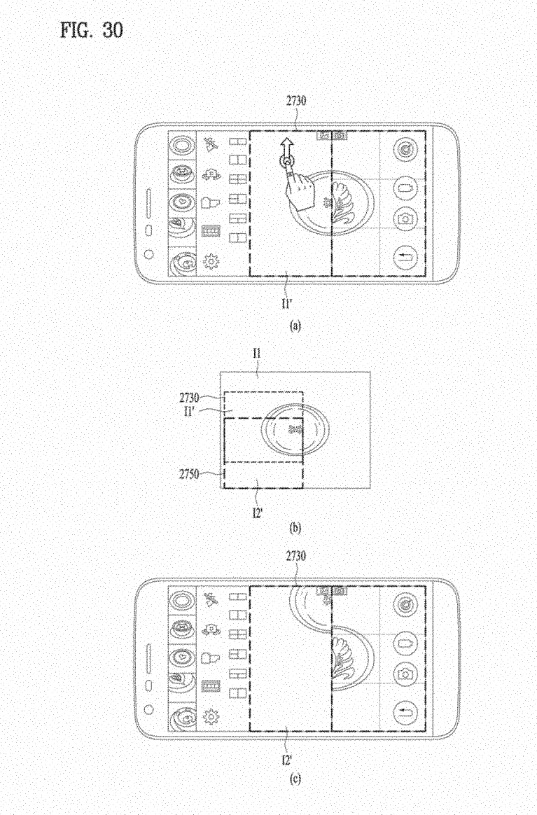

In more detail, referring to (a) of FIG. 30, the controller 180 may sense a second input for dragging one point within the third area 2730 to a specific direction after touching the one point within the third area 2730 in a state that the part IF of the first image is displayed on the third area 2730. In this case, referring to (b) of FIG. 30, the part IF of the first image displayed on the third area 2730 may be a part corresponding to the third area 2730 within the first image I1.

The controller 180 may change the position of the third area 2730 within the first image I1 on the basis of at least one of a drag length of the second input and a drag direction of the second input. That is, the controller 180 may change the position of the third area 2730 within the first image I1 to the fifth area 2750 on the basis of at least one of a drag length of the second input and a drag direction of the second input. Referring to (c) of FIG. 30, the controller 180 may control the display unit 151 to display a part 12′ corresponding to the fifth area 2750 within the first image I1 on the third area 2730 within the execution screen.

For example, in accordance with a second input one point within the third area 2730 of the execution screen to an upward direction after touching the one point, the controller 180 may change the third area 2730 within the first image I1 to the fifth area 2750 existing below (or above) the third area 2730. The controller 180 may control the display unit 151 to display the part corresponding to the fifth area 2750 within the first image I1 on the third area 2730 within the execution screen as shown in (c) of FIG. 30. In this case, the position of the third area 2730 within the first image I1 is changed to an opposite direction of the drag direction.

As a result, the controller 180 may control the display unit 151 to display a part of the first image I1, which is not displayed on the third area 2730 within the execution screen, on the third area 2730 in accordance with the second input.

Meanwhile, in accordance with a third input, the controller 180 may downsize or upsize the part IF of the first image displayed on the third area 2730. In this case, the controller 180 may upsize or downsize only the part IF of the first image without upsizing or downsizing the part PI′ of the preview image.

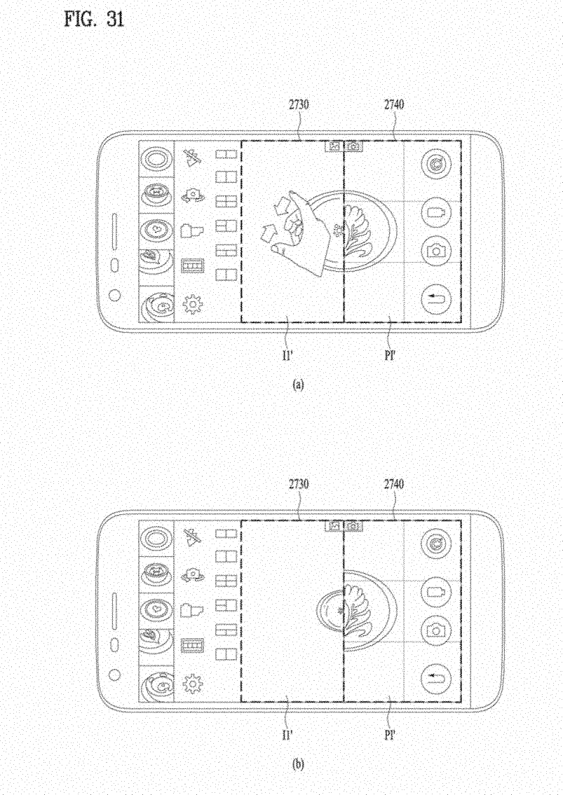

For example, referring to (a) of FIG. 31, the controller 180 may sense a touch input for dragging two random points within the third area 2730 of the execution screen to a direction close to each other after touching the two points. In this case, the controller 180 may downsize the part IF of the first image displayed on the third area 2730 as shown in (b) of FIG. 31 in accordance with the touch input.

For another example, the controller 180 may sense a touch input for dragging two random points within the third area 2730 of the execution screen to a direction far away from each other after touching the two points. In this case, the controller 180 may upsize the part I1′ of the first image displayed on the third area 2730 in accordance with the touch input.

According to this embodiment, it is advantageous that the user may control the image displayed on the execution screen of the camera application.

Meanwhile, according to one embodiment of the present invention, the controller 180 may control the display unit 151 to display the plurality of images on the execution screen of the camera application together with the preview image on the basis of the input of the user. This will be described in more detail with reference to FIGS. 32 to 34.

FIG. 32 is a view illustrating an example of a method for displaying a plurality of images together with a preview image on an execution screen of a camera application in a mobile terminal according to one embodiment of the present invention. Repeated description of the description made with reference to FIGS. 26 to 31 will be omitted in FIG. 32, and the example of FIG. 32 will be described based on a difference from FIGS. 26 to 31.

Referring to (a) of FIG. 32, the controller 180 may control the display unit 151 to display a part IF of a first image corresponding to a first thumbnail image on a third area 2730 within an execution screen of a camera application and display a part PI′ of a preview image on a fourth area 2740 within the execution screen. In this case, the third area 2730 and the fourth area 2740 may be included in a first area 2710.

Meanwhile, the controller 180 may control the display unit 151 to display a window W1 related to split setup on the execution screen. The controller 180 may newly split the first area 2710 in accordance with an input for selecting any one of a plurality of indicators displayed on the window W1. In this case, a method for splitting the first area 2710 may be changed depending on an indicator selected by the user.

For example, the controller 180 may sense a first input for touching an indicator C corresponding to a function of splitting a screen to three areas, among the plurality of indicators displayed on the window W1. In this case, the controller 180 may split the first area 2710 within the execution screen into three areas as shown in (b) of FIG. 32 in accordance with the first input.

In more detail, the controller 180 may split only the third area into a fifth area 2750 and a sixth area 2760 without splitting the fourth area 2740 in accordance with the first input.

Meanwhile, the controller 180 may control the display unit 151 to display the part PI′ of the preview image on the fourth area 2740.

The controller 180 may control the display unit 151 to display the part IF of the first image on the fifth area 2750. In this case, the part IF of the first image may be a part corresponding to the fifth area 2750 within the first image.

The controller 180 may control the display unit 151 to display an indicator D, which indicates an image adding function, on the sixth area 2760.

Meanwhile, the controller 180 may control the display unit 151 to display a part of an image corresponding to the above input on the sixth area 2760 in accordance with a second input.

For example, the second input may be a touch input for dragging a second thumbnail T2 among the plurality of thumbnail images displayed on the second area 2720 toward the sixth area 2760 after touching the second thumbnail image T2 as shown in (b) of FIG. 32. In this case, the image corresponding to the second input may be an image corresponding to the second thumbnail image T2.

For another example, the second input may be an input for selecting any one of images stored in the memory after touching the indicator D, which indicates the image adding function, in (b) of FIG. 32.

Meanwhile, referring to (c) of FIG. 32, the controller 180 may control the display unit 151 to display a part 12′ of the image (for example, second image) corresponding to the second input on the sixth area 2760. In this case, the part 12′ of the second image may be a part corresponding to the sixth area 2760 within the second image.

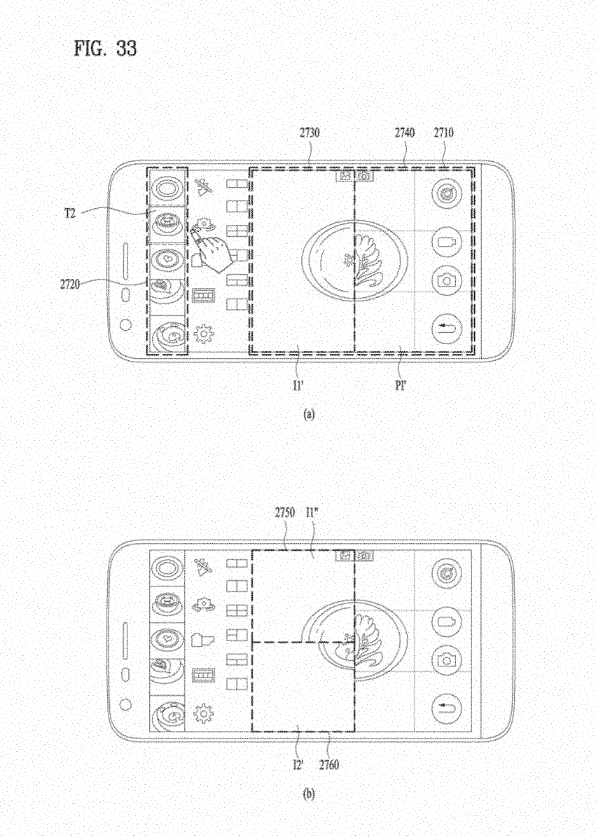

FIG. 33 is a view illustrating another example of a method for displaying a plurality of images together with a preview image on an execution screen of a camera application in a mobile terminal according to one embodiment of the present invention. Repeated description of the description made with reference to FIGS. 26 to 32 will be omitted in FIG. 33, and the example of FIG. 33 will be described based on a difference from FIGS. 26 to 32.

Referring to (a) of FIG. 33, the controller 180 may control the display unit 151 to display a part IF of a first image corresponding to a first thumbnail image on a third area 2730 within an execution screen of a camera application and display a part PI′ of a preview image on a fourth area 2740 within the execution screen. In this case, the third area 2730 and the fourth area 2740 may be included in a first area 2710.

The controller 180 may split the first area 2710 into three areas in accordance with a first input. In more detail, the controller 180 may split only the third area into a fifth area 2750 and a sixth area 2760 without splitting the fourth area 2740 in accordance with the first input.

In this case, the first input may be an input for touching the second thumbnail T2 of the plurality of thumbnail images displayed on the second area 2720 at a predetermined pressure for a predetermined time. However, the input for splitting the first area 2710 is not limited to the first input.

Meanwhile, referring to (b) of FIG. 33, the controller 180 may control the display unit 151 to continue to display the part PI′ of the preview image on the fourth area 2740.

The controller 180 may control the display unit 151 to display the part IF of the first image on the fifth area 2750. In this case, the part IF of the first image may be a part corresponding to the fifth area 2750 within the first image.

The controller 180 may control the display unit 151 to display a part of the image selected by the first input on the sixth area 2760. In this case, the selected image may be a second image corresponding to the second thumbnail image T2.

Therefore, the controller 180 may control the display unit 151 to display a part 12′ of the second image on the sixth area 2760 in accordance with the first input. The part of the second image may be a part corresponding to the sixth area 2760 within the second image.

However, without limitation to this case, a part 12″ of the second image may be displayed on the fifth area 2750 and a part I1″ of the first image may be displayed on the sixth area 2760. In this case, the part I1″ of the first image may be a part corresponding to the sixth area 2760 within the first image, and the part 12″ of the second image may be a part corresponding to the fifth area 2750 within the second image.

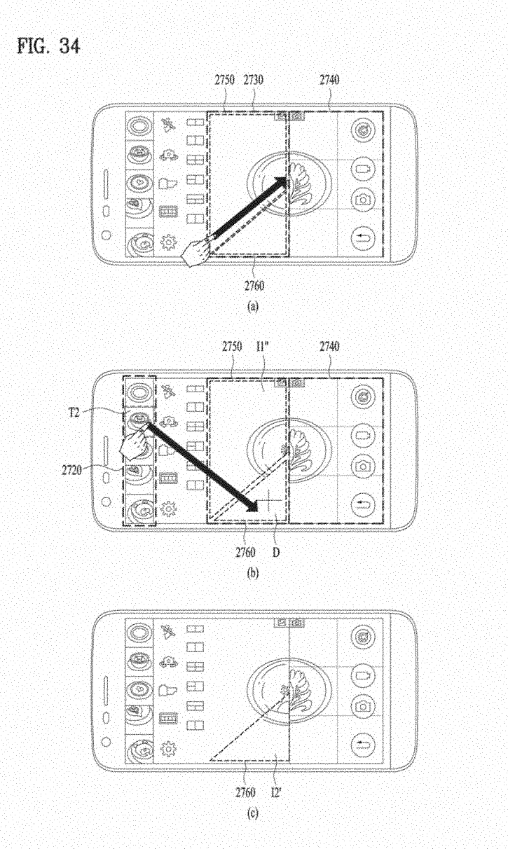

FIG. 34 is a view illustrating other example of a method for displaying a plurality of images together with a preview image on an execution screen of a camera application in a mobile terminal according to one embodiment of the present invention. Repeated description of the description made with reference to FIGS. 26 to 33 will be omitted in FIG. 34, and the example of FIG. 34 will be described based on a difference from FIGS. 26 to 33.

Referring to (a) of FIG. 34, the controller 180 may control the display unit 151 to display a part IF of a first image corresponding to a first thumbnail image on a third area 2730 within an execution screen of a camera application and display a part PI′ of a preview image on a fourth area 2740 within the execution screen. In this case, the third area 2730 and the fourth area 2740 may be included in a first area 2710.

Meanwhile, the user may freely split the third area 2730 in a desired method. For example, if the user desires to the third area 2730 into a fifth area 2750 and a sixth area 2760 as shown in (a) of FIG. 34, the user has only to drag a boundary between the fifth area 2750 and the sixth area 2760 at a predetermined pressure. In this case, the controller 180 may split the third area 2760 into the fifth area 2750 and the sixth area 2760 in accordance with a touch input for dragging the third area along the boundary.

Although the description of this embodiment is limited to the method for splitting the third area 2730, the fourth area 2740 may be split in the same manner as the method for splitting the third area 2730.

Meanwhile, the controller 180 may control the display unit 151 to continue to display the part PI′ of the preview image on the fourth area 2740.

The controller 180 may control the display unit 151 to display the part IF of the first image on the fifth area 2750. In this case, the part IF of the first image may be a part corresponding to the fifth area 2750 within the first image.

The controller 180 may control the display unit 151 to display an indicator D, which indicates an image adding function, on the sixth area 2760. However, without limitation to this case, the controller 180 may display the part of the first image on the fifth area 2750 and the sixth area 2760 by splitting the third area 2730 without displaying the indicator D.

Meanwhile, the controller 180 may control the display unit 151 to display a part of an image corresponding to the second input on the sixth area 2760 in accordance with a second input.

For example, the second input may be a touch input for dragging a second thumbnail T2 of the plurality of thumbnail images displayed on the second area 2720 toward the sixth area 2760 after touching the second thumbnail image T2 as shown in (b) of FIG. 34. In this case, the image corresponding to the second input may be an image corresponding to the second thumbnail image T2.

For another example, the second input may be an input for selecting any one of images stored in the memory after touching the indicator D, which indicates the image adding function, in (b) of FIG. 34.

Meanwhile, referring to (c) of FIG. 34, the controller 180 may control the display unit 151 to display a part 12′ of the image (for example, second image) corresponding to the second input on the sixth area 2760. In this case, the part 12′ of the second image may be a part corresponding to the sixth area 2760 within the second image.

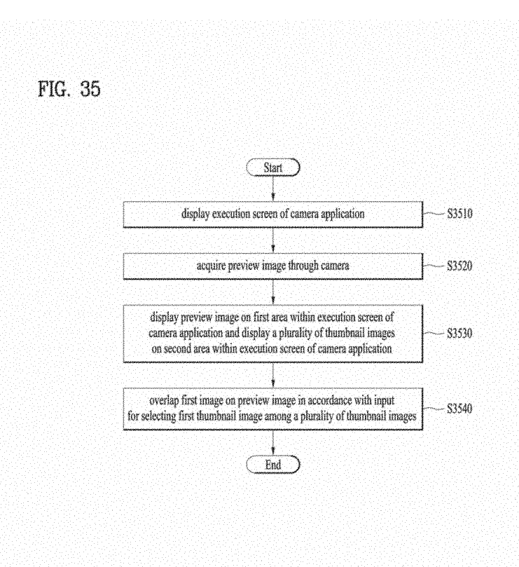

FIG. 35 is a flow chart illustrating another example of a method for using images stored in a memory when taking an image in a mobile terminal according to one embodiment of the present invention. Repeated description of the description made with reference to FIGS. 26 to 34 will be omitted in FIG. 35, and the example of FIG. 35 will be described based on a difference from FIGS. 26 to 34.

According to one embodiment of the present invention, the memory 170 may store a plurality of images therein. In this case, the plurality of images may include images acquired through the camera, images acquired through capturing, images received from an external server or an external device, etc.

However, without limitation to this case, images may not be stored in the memory 170, or only one image may be stored in the memory 170. For convenience of description, it is assumed that a plurality of images are stored in the memory 170. The embodiments which will be described hereinafter may be applied to even the case that one image is stored in the memory 170 or the case that no image is stored therein.

The camera application may be stored in the memory 170. The camera application may be stored in the memory 170 from the release timing, may be installed during upgrade of an application program or firmware, or may separately be stored in the memory 170 by the user.

The controller 180 may control the display unit 151 to display the execution screen of the camera application in accordance with an execution command of the camera application (S3510).

Meanwhile, the controller 180 may enable the camera 121 in accordance with the execution command of the camera application. The enabled camera 121 may acquire a preview image (S3520). The preview image means an image acquired through the camera in real time.

The controller 180 may control the display unit 151 to display the preview image acquired through the enabled camera and a plurality of thumbnail images respectively corresponding to the plurality of images stored in the memory 170 on the execution screen.

In more detail, the controller 180 may control the display unit 151 to display the preview image on a first area within the execution screen of the camera application and display the plurality of thumbnail images on a second area within the execution screen (S3530). In this case, the first area and the second area may be those different from each other.

Meanwhile, in accordance with an input for selecting a first thumbnail image among the plurality of thumbnail images displayed on the second area, the controller 180 may control the display unit 151 to overlap a first image corresponding to the first thumbnail image on the preview image (S3540). In this case, the first image may have transparency. Therefore, the preview image may be seen to be reflected in the first image.

According to this embodiment, it is advantageous that the user may easily follow a composition of an image of a specialist or a well-taken image even though the user is not a photo specialist.

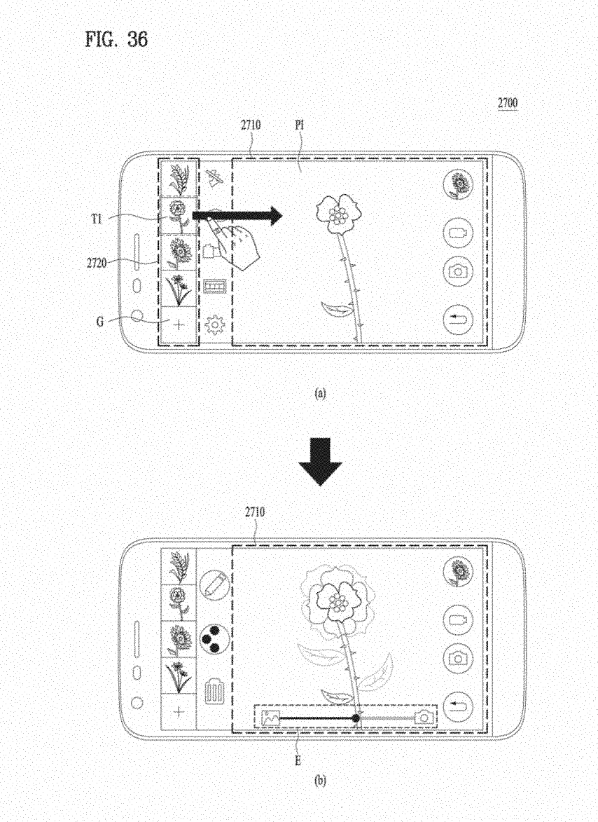

FIG. 36 is a view illustrating another example of a method for using images stored in a memory when taking an image in a mobile terminal according to one embodiment of the present invention. Repeated description of the description made with reference to FIGS. 26 to 35 will be omitted in FIG. 36, and the example of FIG. 36 will be described based on a difference from FIGS. 26 to 35.

According to one embodiment of the present invention, the controller 180 may control the display unit to display an execution screen 2700 of the camera application.

Hereinafter, for convenience of description, it is assumed that the mobile terminal 100 is, but not limited to, a horizontal mode.

In this case, the horizontal mode may mean the state that a top end of the mobile terminal is headed for a left side or a right side, or may mean the state that the top end of the mobile terminal is not headed for a downward side or an upward side.

Referring to (a) of FIG. 36, the controller 180 may control the display unit 151 to display a preview image PI acquired through the camera on a first area 2710 within the execution screen.

The controller 180 may control the display unit 151 to display a plurality of thumbnail images corresponding to a plurality of images stored in the memory 170 on a second area 2720 within the execution screen. However, without limitation to this, the plurality of thumbnail images may be displayed on the preview image PI.

Meanwhile, since the size of the display unit 151 is limited, all of the plurality of thumbnail images stored in the memory 170 cannot be displayed on the second area 2720. Therefore, the controller 180 may control the display unit 151 to display the thumbnail images in accordance with a certain order. Since this has been described with reference to FIG. 27, its detailed description will be omitted.

Meanwhile, according to one embodiment of the present invention, the controller 180 may control the display unit 151 to display the plurality of thumbnail images corresponding to images located in a specific folder among the plurality of images stored in the memory 170 on the second area 2720. In this case, the specific folder may be a folder selected by the user.

Meanwhile, according to one embodiment of the present invention, the controller 180 may control the display unit 151 to display an indicator G corresponding to an image adding function on the second area 2720. The controller 180 may control the display unit 151 to additionally display the images stored in the memory 170, images uploaded in a specific external server, and images searched through Internet on the second area 2720 in accordance with an input for selecting the indicator G

In accordance with a first input for selecting a first thumbnail image Ti among the plurality of thumbnail images displayed on the second area 2720 within the execution screen 2700 as shown in (a) of FIG. 36, the controller 180 may control the display unit 151 to display a first image corresponding to the first thumbnail image Ti on the first area 2710 by overlapping the first image on the preview image PI as shown in (b) of FIG. 36. In this case, the first image overlapped on the preview image PI may have transparency.

In this case, the first input may be a touch input for dragging the first thumbnail image T1 toward the first area 2710 after touching the first thumbnail image T1 at a predetermined pressure for a predetermined time as shown in (a) of FIG. 36. However, without limitation to this, the first input may include a touch input for touching the first thumbnail image Ti at a predetermined pressure, a touch input for touching the first thumbnail image Ti for a predetermined time, etc.

Referring to (b) of FIG. 36 again, in accordance with the first input, the controller 180 may control the display unit 151 to overlap the first image having transparency on the first area 2710 in a state that the preview image is displayed on the first area 2710.

Meanwhile, the controller 180 may control the display unit 151 to display an indicator E, which controls transparency of the first image, on the execution screen. Referring to (b) of FIG. 36, the indicator E is displayed on the first area 2710 but may be displayed on another area without limitation to the example of FIG. 36.

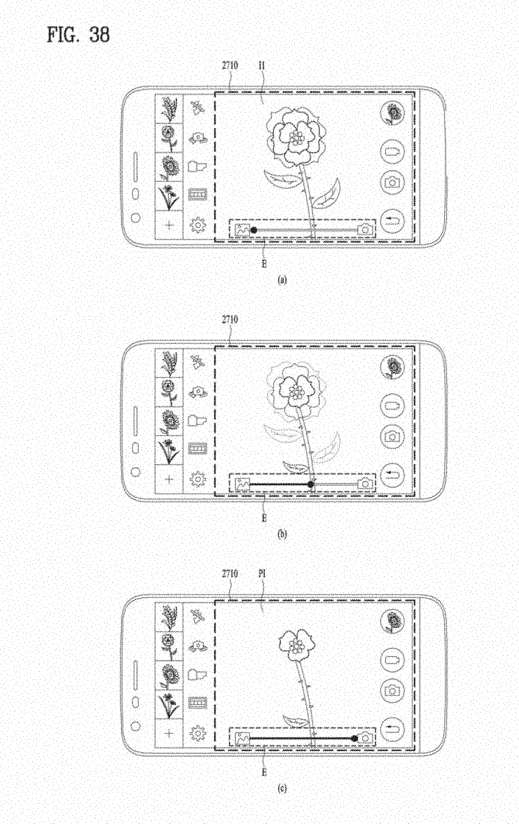

Meanwhile, the user may control transparency of the first image by using the indicator E. This will be described in more detail with reference to FIG. 38.

Meanwhile, according to one embodiment of the present invention, the controller 180 may store the preview image in the memory 170 by capturing the preview image in accordance with an image capturing command. In this case, the controller 180 may store at least one of the preview image on which the first image is overlapped and the preview image on which the first image is not overlapped, in the memory 170.

If only the preview image on which the first image is not overlapped is stored in the memory 170, the first image serves to guide image capturing.

According to this embodiment, it is advantageous that the user may easily follow a composition of an image of a specialist or a well-taken image even though the user is not a photo specialist.

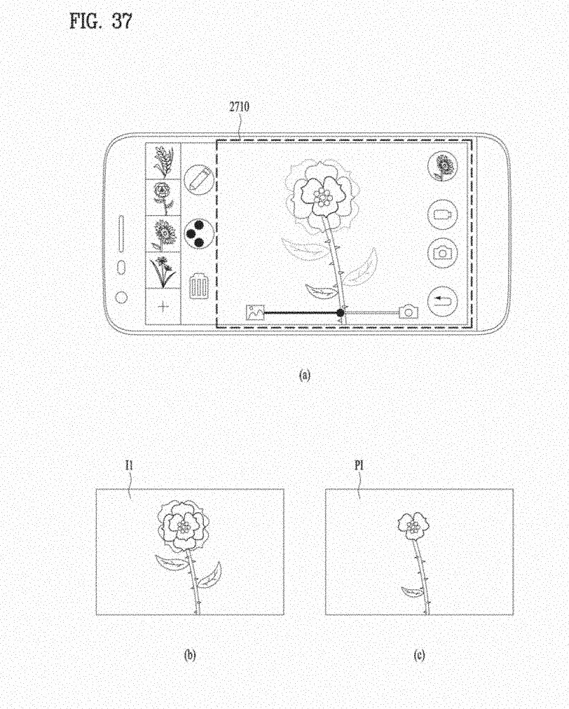

FIG. 37 is a view illustrating an example of a method for overlapping images stored in a memory on a preview image acquired through a camera in a mobile terminal according to one embodiment of the present invention. Repeated description of the description made with reference to FIGS. 26 to 36 will be omitted in FIG. 37, and the example of FIG. 37 will be described based on a difference from FIGS. 26 to 36.

Hereinafter, it is assumed that a first image I1 corresponding to a first thumbnail image is selected in accordance with a first input for selecting the first thumbnail image and a preview image PI is acquired through a camera.

Referring to (a) of FIG. 37, the controller 180 may control the display unit 151 to overlap the first image I1 shown in (b) of FIG. 37 on the preview image PI in a state that the preview image PI shown in (c) of FIG. 37 is displayed on a first area 2710 in accordance with the first input. In this case, the first image I1 may have transparency. That is, the preview image PI may be seen to be reflected in the first image I1.

However, without limitation to this case, the preview image PI may have transparency. The first image I1 may be overlapped on the preview image PI in a state that the preview image PI is displayed on the first area 2710. In this case, the first image I1 may be seen to be reflected in the preview image PI.

Meanwhile, according to one embodiment of the present invention, the controller 180 may capture the preview image and then store the captured preview image in the memory 170 in accordance with a capturing command. In this case, the controller 180 may store at least one of the preview image on which the first image is overlapped and the preview image on which the first image is not overlapped.

For example, the controller 180 may store only the preview image PI shown in (c) of FIG. 37 in the memory 170.

For another example, the controller 180 may store the first image overlapped on the preview image displayed on the first area 2710 of (a) of FIG. 37 and the preview image PI of (c) of FIG. 37 together in the memory 170.

FIG. 38 is a view illustrating an example of a method for controlling transparency of an image in a mobile terminal according to one embodiment of the present invention. Repeated description of the description made with reference to FIGS. 26 to 37 will be omitted in FIG. 38, and the example of FIG. 38 will be described based on a difference from FIGS. 26 to 37.

Hereinafter, it is assumed that a preview image is displayed on a first area 2710 within an execution screen of a camera application, a first image is overlapped on the preview image, and the first image has transparency. However, the present invention is not limited to this assumption.

Referring to (a) of FIG. 38, if the user sets transparency of the first image to a minimum value by using an indicator E for controlling transparency of the first image displayed on the first area, the controller 180 may set transparency of the first image I1 to the minimum value.

In this case, since the first image I1 overlapped on the preview image PI does not have transparency, only the first image I1 may be displayed on the first area 2710, and the preview image may not be displayed on the first area 2710. That is, if the user sets transparency of the first image to a minimum value by using the indicator E, the user may view only the first image on the first area 2710.

Referring to (b) of FIG. 38, if the user sets the first image to be transparent using the indicator E, the controller 180 may set the first image I1 to have transparency corresponding to the value set by the indicator E.

In this case, since the first image I1 displayed on the preview image PI has transparency, the preview image may be seen to be reflected in the first image I1.

Referring to (c) of FIG. 38, if the user sets transparency of the first image to a maximum value using the indicator E, the controller 180 may set transparency of the first image I1 to a maximum value.

In this case, since the first image I1 displayed on the preview image PI becomes fully transparent, only the preview image PI may be displayed on the first area 2710, and the first image may not be displayed on the first area 2710. That is, the user may view only the preview image PI on the first area 2710.

According to this embodiment, it is advantageous that the user may use transparency of the first image to take an image by freely controlling the transparency of the first image.

According to at least one of the aforementioned embodiments, it is advantageous that the user may perform split capturing of various images according to a recent trend. Also, it is advantageous that the user may easily follow a composition of an image of a specialist or a well-taken image even though the user is not a photo specialist.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

### INDUSTRIAL APPLICABILITY

The present invention relates to a mobile terminal and a method for controlling the same. Therefore, the present invention has industrial applicability.

What is claimed is:

1. A mobile terminal comprising:
a memory configured to store a plurality of images;
a display unit configured to display an execution screen of a camera application;
a camera configured to acquire a preview image; and
a controller configured to control the display unit to display the preview image on a first area within the execution screen,
wherein the controller is further configured to control the display unit to display a plurality of thumbnail images corresponding to the plurality of images stored in the memory on a second area within the execution screen.

2. The mobile terminal according to claim 1, wherein the controller is further configured to:
in response to a first input for selecting a first thumbnail image, control the display unit to display a part of the preview image and a part of a first image corresponding to the first thumbnail image among the plurality of thumbnail images on the first area.

3. The mobile terminal according to claim 2, wherein the controller is further configured to:
in response to the first input, split the first area into a third area and a fourth area, and
control the display unit to display a part of the first image on the third area and display a part of the preview image on the fourth area.

4. The mobile terminal according to claim 3, wherein the part of the first image corresponds to a part corresponding to the third area within the first image, and
wherein the part of the second image corresponds to a part corresponding to the fourth area within the preview image.

5. The mobile terminal according to claim 1, wherein the controller is further configured to:
in response to a third input for capturing an image, acquire the part of the first image and the part of the preview image as one image, and
store the acquired image in the memory.

6. The mobile terminal according to claim 1, wherein the controller is further configured to:
in response to the first input for selecting the first thumbnail image among the plurality of thumbnail images, control the display unit to display the first image corresponding to the first thumbnail image instead of the preview image on the first area within the execution screen.

7. The mobile terminal according to claim 6, wherein the first input is a touch input for touching the area on which the first thumbnail image is displayed at a predetermined pressure.

8. The mobile terminal according to claim 6, wherein the controller is further configured to control the display unit to display an indicator corresponding to a process function of the first image instead of an indicator corresponding to functions of the camera application on the third area if the first image is displayed instead of the preview image.

9. The mobile terminal according to claim 1, wherein the controller is further configured to:
control the display unit to recognize an object within the preview image,
extract an image, which includes an object corresponding to the recognized object, among the plurality of images stored in the memory, and
display a thumbnail image corresponding to the extracted image on the second area.

10. A mobile terminal comprising:
a memory configured to store a plurality of images;
a display unit configured to display an execution screen of a camera application;
a camera configured to acquire a preview image; and
a controller configured to control the display unit to display the preview image on a first area within the execution screen,
wherein the controller is further configured to:
control the display unit to display a plurality of thumbnail images corresponding to a plurality of images stored in the memory on a second area within the execution screen, and
in response to a first input for selecting the first thumbnail image among the plurality of thumbnail images, control the display unit to overlap a first image corresponding to the first thumbnail image on the preview image,
wherein the first image is transparent.
